(19) United States
(12) Patent Application Publication
(10) Pub. No.: US 2026/0338948 A1
(43) Pub. Date: Oct. 29, 2026

(54) BISTATIC SENSOR SYSTEM

(71) Applicant: TEXAS INSTRUMENTS INCORPORATED, Dallas, TX (US)

(72) Inventors: Yao Yu, San Jose, CA (US); Yande Peng, Santa Clara, CA (US); Ting-Ta Yen, San Jose, CA (US)

(21) Appl. No.: 19/333,690

(22) Filed: Sep. 19, 2025

Related U.S. Application Data
(60) Provisional application No. 63/794,453, filed on Apr. 25, 2025.
(60) Provisional application No. 63/853,127, filed on Jul. 29, 2025.

(51) Int. Cl. G01S 15/00; G01S 7/521; G01S 7/524; G01S 7/527

(52) U.S. Cl. CPC G01S 15/003; G01S 7/521; G01S 7/524; G01S 7/527

(57) ABSTRACT

In an example embodiment, a packaged integrated circuit is provided that includes a first acoustic transducer, a second acoustic transducer, a transmit circuit coupled to the first acoustic transducer, a receive circuit coupled to the second acoustic transducer, a control circuit coupled to an output of the receive circuit, and a package material covering at least parts of the first acoustic transducer, the second acoustic transducer, the transmit circuit, the receive circuit, and the control circuit.

### RELATED APPLICATIONS

This application hereby claims the benefit and priority to U.S. Provisional Application No. 63/794,453, titled “INTEGRATED BISTATIC ULTRASONIC SENSOR WITH OFF-RESONANCE EXCITATION,” filed Apr. 25, 2025, and to U.S. Provisional Application No. 63/853,127, titled “BISTATIC ULTRASONIC SENSOR WITH RECONFIGURABLE FIELD OF VIEW,” filed Jul. 29, 2025, and is related to U.S. Application filed under Attorney Docket Number T106470US02, titled “ACOUSTIC WAVEGUIDE FOR BISTATIC SENSOR SYSTEM,” filed concurrently on [date here], which are each hereby incorporated by reference in their entirety.

### BACKGROUND

Transducers can convert energy from one form to another. One example of transducer is an acoustic transducer, which can be used to enable objection detection and measurement of physical phenomena such as distance, proximity, or presence, through emission and reception of signals like acoustic waves. Acoustic sensing systems can employ two primary configurations: monostatic and bistatic. In a monostatic configuration, a single acoustic transducer alternates between transmitting signals and receiving echoes. A bistatic configuration has separate transmitter and receiver transducers.

### SUMMARY

In an example embodiment, a packaged integrated circuit is provided that includes a first acoustic transducer, a second acoustic transducer, a transmit circuit coupled to the first acoustic transducer, a receive circuit coupled to the second acoustic transducer, a control circuit coupled to an output of the receive circuit, and a package material covering at least parts of the first acoustic transducer, the second acoustic transducer, the transmit circuit, the receive circuit, and the control circuit.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1A and FIG. 1B are schematics illustrating a packaged integrated circuit including a bistatic sensor and its application, according to various examples.

FIG. 2 is a schematic illustrating circuitry coupled to a bistatic sensor, according to various examples.

FIGS. 3, 4, and 5 are schematics illustrating a packaged integrated circuit including a bistatic sensor system, according to various examples.

FIGS. 6A, 6B, 6C, and 6D are schematics illustrating a packaged integrated circuit including a bistatic sensor system, according to various examples.

FIGS. 7A, 7B, 7C, and 7D are schematics illustrating a packaged integrated circuit including a bistatic sensor system, according to various examples.

FIG. 8 includes graphs illustrating effects on sensitivity of a bistatic sensor due to resonant frequency mismatches between transmit and receive transducers, according to various examples.

FIG. 9 is a schematic illustrating sources of cross-talk within a packaged integrated circuit including a bistatic sensor, according to various examples.

FIG. 10 includes graphs illustrating operations of a bistatic sensor system including transmit and receive transducers having different resonant frequencies, according to various examples.

FIG. 11 is a schematic illustrating a system including a bistatic sensor system, according to various examples.

FIG. 12 is a flowchart illustrating a method of operating a bistatic sensor in an implementation, according to various examples.

FIG. 13 is a schematic illustrating a system including a bistatic sensor system and calibration circuitry, according to various examples.

FIG. 14 includes graphs illustrating a calibration operation illustrates example aspects of a calibration of a bistatic sensor, according to various examples.

FIG. 15 is a flowchart illustrating a method of calibrating a bistatic sensor system, according to various examples.

FIG. 16 is a schematic illustrating a computing device that can implement various methods of operating a bistatic sensor, according to various examples.

FIGS. 17, 18, 19, and 20 are schematics illustrating a packaged integrated circuit including a bistatic sensor system, according to various examples.

FIG. 21 is a schematic illustrating an acoustic waveguide, according to various examples.

FIGS. 22A, 22B, and 23 illustrate transmission of acoustic signals by an acoustic waveguide, according to various examples.

FIG. 24 includes a graph illustrating the signal directivity of a sensor package including an acoustic waveguide, according to various examples.

FIG. 25 includes a graph illustrating a relationship between the signal directivity of a sensor package including an acoustic waveguide and a dimension of the acoustic waveguide, according to various examples.

FIG. 26A includes schematics illustrating transmit and receive operations of a sensor package, and FIG. 26B includes graphs illustrating the transmit and receive signal directivities of the sensor package, according to various examples.

FIGS. 27 and 28 illustrate signal directivity patterns of an acoustic waveguide, according to various examples.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

As described above, acoustic sensing systems can employ two primary configurations: monostatic and bistatic. In a monostatic sensor system, a single acoustic transducer alternates between transmitting signals and receiving echoes, which simplifies design and reduces component count. Monostatic sensors, despite their compact design and cost efficiency, face challenges with ring-down effects, which can affect the detection of nearby objects. Ring-down occurs when the transducer vibrates after transmission, producing residual signals that mask incoming echoes from close-range targets, which makes it challenging to detect those close-range targets.

On the other hand, a bistatic sensor system has separate transmit and receive acoustic transducers. Such arrangements allows the transmit acoustic transducer to transmit a signal and the receive acoustic transducer to receive a different signal simultaneously, and the ring-down effects can be avoided. However, various issues may affect the performance of a bistatic sensor system. First, the transmit and receive acoustic transducers may be designed to have a same resonant frequency. The transmit acoustic transducer may be driven to transmit an outbound signal having the resonant frequency to maximize efficiency, while the receive acoustic transducer may detect an inbound signal having the resonant frequency to maximize sensitivity. However, due to various reasons, such as aging, environmental stress, temperature variations, and manufacturing tolerances, the resonant frequencies of the transmit and receive acoustic transducers may drift, leading to resonant frequency mismatches between the transmit and receive acoustic transducers. Such mismatches can reduce sensitivity on the receive side, especially if the transmit acoustic transducer is driven at a frequency different from the resonant frequency of the receive acoustic transducer. Second, cross-talking may occur between the transmit and receive acoustic transducers. Due to the cross-talking, some of the outbound signal transmitted by the transmit acoustic transducer may be coupled into the receive acoustic transducer, which can introduce errors in echo interpretation and lead to false detections. Further, in a case where the transmitter and receiver transducers share a single waveguide, diffraction may occur within the waveguide, leading to a blind spot in the field of view (FoV) where the transmitted signal has a very low intensity, or the echo sensitivity becomes very low. An object in the blind spot may become very difficult to be detected by the bistatic sensor system.

Examples disclosed herein can mitigate at least some of the problems discussed above. In some examples, a bistatic sensor system includes transmit and receive acoustic transducers having different resonant frequencies by design/configuration, such that the resonant frequencies differ more than due to random mismatch (e.g., 3%)). In some examples, the transmit and receive acoustic transducers are designed/configured (e.g., based on device sizes, materials, etc.) such that their 3 dB frequency ranges around the respective resonant frequencies do not overlap with each other. In operation of the bistatic sensor system, the transmit acoustic transducer is excited at the resonant frequency of the receive acoustic transducer to generate the outbound signal, which can improve the sensitivity of the receive acoustic transducer in detecting the echo of the outbound signal.

As to be described herein, various techniques can be employed to further improve the sensitivity of the receive acoustic transducer. For example, the amplitude of the excitation voltage provided to the transmit acoustic transducer may be increased to be high enough to saturate the transmit acoustic transducer, such that the outbound signal generated by transmit acoustic transducer produces the same pressure as when the transmit acoustic transducer is excited at its resonant frequency. All these can advantageously improve the sensitivity of the receive acoustic transducer in detecting the acoustic waves, as the acoustic waves are propagated and reflected at specifically the receive acoustic transducer's resonant frequency, rather than at the transmit acoustic transducer's resonant frequency. In some examples, the bistatic sensor system can be designed and operated to maximize the receive acoustic transducer's sensitivity with the assumption that the transmit and receive acoustic transducers have the different resonant frequency, so that the resonant frequency mismatch between the transmit and receive acoustic transducers has very little or no effect on the performance of the bistatic sensor system.

Also, as to be described herein, a calibration operation can be performed to determine a frequency response (e.g., in the form of a transfer function) of the receive acoustic transducer in response to a transmission of an outbound acoustic signal by the transmit acoustic transducer. From the frequency response, cross-talk components present at the output of the receive acoustic transducer, as well as the resonant frequency of the receive acoustic transducer, can be determined. Accordingly, in a detection operation, the echo signal detected by the receive acoustic transducer can be post-processed to eliminate (or at least reduce) the cross-talk components. This allows the transmit and receive acoustic transducers to be integrated in an integrated circuit package and to be brought close to each other without the robustness of the bistatic sensor system being impacted by the increased cross-talking, or at least with the effect of cross-talking mitigated. Further, by determining the actual resonant frequency of the receive acoustic transducer via the calibration operation, the transmit acoustic transducer can be driven at the actual resonant frequency of the receive acoustic transducer. With such arrangements, the drift of the resonant frequency of the receive acoustic transducer (e.g., due to stress, temperature, random device mismatch, etc.) can be tracked, and the effect of the drift on the sensitivity of the receive acoustic transducer can be mitigated, which can further improve the robustness of the bistatic sensor system.

Also, in some examples, the bistatic sensors system may include, or may be coupled to, an acoustic waveguide that can provide separate, symmetrical channels for the transmit and receive transducers, reducing or even eliminating noise and diffraction issues and improving the directivity and efficiency of the transmission and reception of acoustic waves. Specifically, an acoustic waveguide described herein may include separate through openings (e.g., openings that penetrate a body of the acoustic waveguide), each corresponding to and overlapping only one of the transducers of a bistatic sensor device, without the receive and transmit transducers sharing one opening of the acoustic waveguide. Not only are the transducers designed and positioned symmetrically relative to one another with respect to a middle point of the bistatic sensor device, but also the through openings of the acoustic waveguide are designed and positioned symmetrically relative to one another and with respect to a middle point of the bistatic sensor device. This advantageously creates separate, symmetrical paths through which the transmit and receive transducers can output and ingest acoustic waves, respectively. The dimensions, shape, and positioning of the transducers and acoustic waveguide through openings may be selected to accommodate various target directivity patterns of the bistatic sensor system.

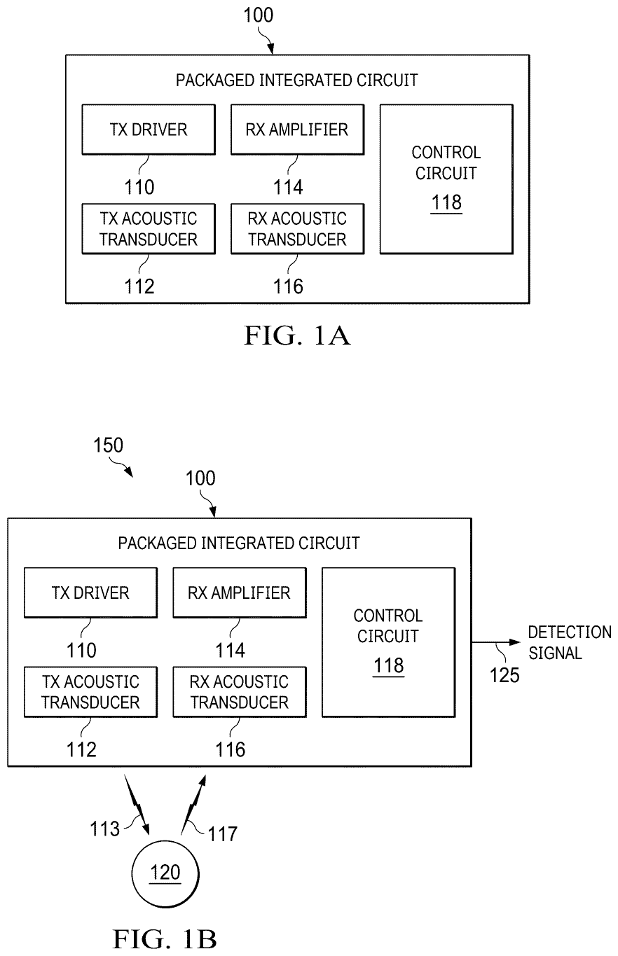

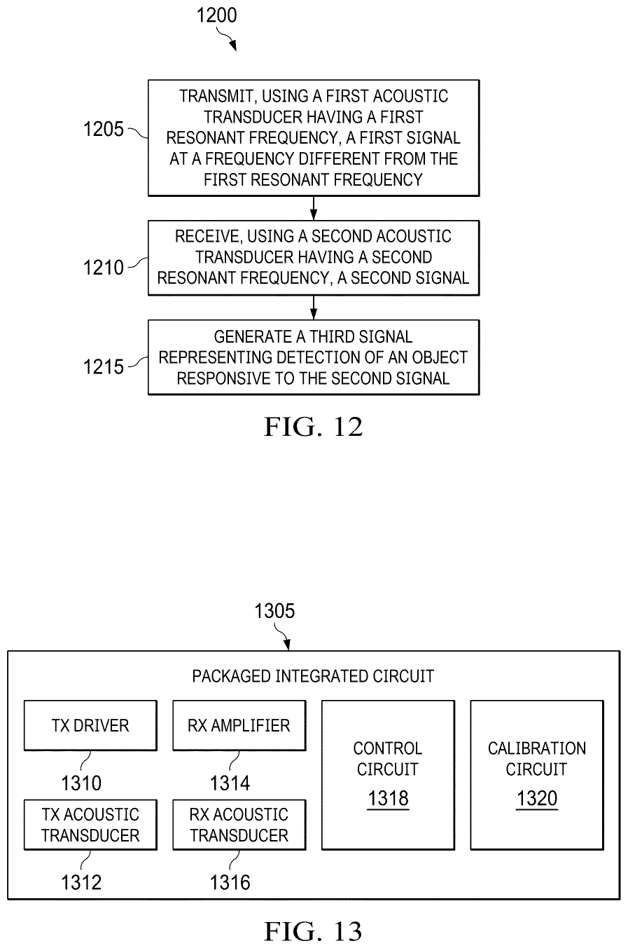

Turning now to the drawings, FIG. 1A illustrates a block diagram of a packaged integrated circuit (IC) 100, which includes a transmit (TX) driver 110, a transmit acoustic transducer 112, a receive (RX) amplifier 114, a receive acoustic transducer 116, and a control circuit 118. Control circuit 118 may be configurable to perform signal transmission, signal reception, digital signal processing, and object detection operations, among other operations, with respect to various other elements of packaged integrated circuit 100, such as operations of method 1200 of FIG. 12. Accordingly, control circuit 118 may include hardware, software, and/or firmware, as well as combinations and variations thereof, for performing the operations described herein, an example of which is shown by computing system 1601 of FIG. 16. In various examples, packaged integrated circuit 100 is representative of a circuit including various electronic, electrical, and hardware components integrated into a single package covered, at least partially, by a package material (e.g., a metal material, a plastic material). Elements of packaged integrated circuit 100 may be configurable to perform ultrasonic sensing operations, digital signal processing operations, object detection operations, and the like, as described herein.

Transmit acoustic transducer 112 may be representative of an acoustic transducer configurable to receive electrical signals and produce acoustic waves as outbound signals that propagate out of packaged IC 100. In various examples, transmit acoustic transducer 112 has a first resonant frequency and a first 3 dB frequency range centered around the first resonant frequency. At the first resonant frequency, transmit acoustic transducer 112 can vibrate and generate the acoustic waves with a maximum amplitude when excited by the electrical signals. Also, within the first 3 dB frequency range, the amplitude of the acoustic waves generated by the transmit acoustic transducer 112 can be within 50% or more of the maximum amplitude at the first resonant frequency. The first resonant frequency may be determined based on various properties of transmit acoustic transducer 112, such as material characteristics, dimensions, and structural characteristics. In other words, transmit acoustic transducer 112 operates most efficiently when excited at the first resonant frequency, thus converting electrical energy into acoustic energy with minimal energy loss relative to excitation at other frequencies.

Receive acoustic transducer 116 may be representative of an acoustic transducer configurable to receive incoming acoustic waves (e.g., sound pressure variations) and convert the acoustic waves into electrical signals. When the acoustic waves reach receive acoustic transducer 116, the acoustic waves induce mechanical vibrations in a material of receive acoustic transducer 116, which generates an electrical signal (e.g., through a piezoelectric effect) having a voltage proportional to the intensity of the acoustic pressure. In various examples, receive acoustic transducer 116 has a second resonant frequency and a second 3 dB frequency range centered around the second resonant frequency, where the second 3 dB frequency range is different from and does not overlap with the first 3 dB frequency range. In some examples, the difference between the first and second resonant frequencies can be several orders of magnitudes higher than a difference caused by a random mismatch between transducers configurable to have the same resonant frequency. Acoustic transducer 116 can vibrate and convert acoustic waves into electrical signals with a maximum efficiency at the second resonant frequency. The second resonant frequency of receive acoustic transducer 116 may be determined based on various properties of receive acoustic transducer 116, such as material characteristics, dimensions, and structural characteristics.

The combination of transmit acoustic transducer 112 and receive acoustic transducer 116 forms a bistatic sensor within packaged integrated circuit 100 configurable to perform signal transmission and signal reception, respectively, for various applications, such as object detection. In some examples, transmit acoustic transducer 112 and receive acoustic transducer 116 include capacitive micromachined ultrasonic transducers (CMUTs). In some examples, transmit acoustic transducer 112 and receive acoustic transducer 116 include piezoelectric micromachined ultrasonic transducers (PMUTs). In some examples, transmit acoustic transducer 112 and receive acoustic transducer 116 include ferroelectric capacitors (FeCaps). Other types of transducers, as well as combinations and variations thereof, may be contemplated.

The bistatic sensor formed by transmit acoustic transducer 112 and receive acoustic transducer 116 may perform respective functions via transmit driver 110 and receive amplifier 114. In various examples, transmit driver 110 is representative of circuitry configurable to provide electrical signals to transmit acoustic transducer 112 to control operations thereof. More particularly, transmit driver 110 generates an electrical signal having a voltage and a frequency, with which transmit acoustic transducer 112 generates and emits acoustic waves. The acoustic waves emitted by transmit acoustic transducer 112 may reflect off an object, creating echoes, or reflected acoustic waves. The reflected acoustic waves are received and converted into electrical signals by receive acoustic transducer 116. Receive amplifier 114, representative of circuitry configurable to amplify the electrical signals output by receive acoustic transducer 116 (e.g., an analog front end (AFE)), processes the electrical signals and provides the processed electrical signals downstream to control circuit 118. By way of example, receive amplifier 114 may include one or more filters, amplifiers, gain compensation circuits, and the like, to filter, convert, and/or amplify values of the electrical signals.

Control circuit 118 may be representative of or implemented in one or more processor cores, processing devices, processing systems, or the like configurable to perform functions like object detection based on the processed electrical signals provided to control circuit 118 by receive amplifier 114. Additionally, or alternatively, control circuit 118 may be configurable to control operations of transmit driver 110 and receive amplifier 114, and thus, transmit acoustic transducer 112 and receive acoustic transducer 116, respectively. For example, control circuit 118 may direct transmit driver 110 to provide an electrical signal to transmit acoustic transducer 112 having a target voltage and/or frequency.

Examples of the one or more processor cores include one or more central processing units (CPUs), graphical processing units (GPUs), general purpose processors, microcontroller units, microprocessors, digital signal processors (DSPs), field-programmable gate arrays (FPGAs), application-specific integrated circuits (ASICs), and the like, as well as combinations and variations thereof. As such, control circuit 118 may include hardware, software, and/or firmware with which to further process the processed electrical signals to determine information about an object within proximity of packaged integrated circuit 100, for example.

Referring next to FIG. 1B, FIG. 1B shows an operating environment 150, which includes an example environment in which packaged integrated circuit 100 is located within proximity of object 120 (e.g., a device, a person, a structure). In operating environment 150, packaged integrated circuit 100 transmits signals to object 120 and receives signals reflected off object 120 to sense information about object 120 and generate detection signal 125.

In operation, control circuit 118 directs transmit driver 110 to provide an electrical signal, having a voltage and a frequency, to transmit acoustic transducer 112. Upon receiving the electrical signal from transmit driver 110, transmit acoustic transducer 112 generates acoustic waves 113, which may be emitted out of transmit acoustic transducer 112 and packaged integrated circuit 100 towards an object 120.

Acoustic waves 113 bounce or reflect off object 120, resulting in returning acoustic waves 117 as echo signals, which can have a same frequency as acoustic waves 113 based on the electrical signal provided to transmit acoustic transducer 112. Receive acoustic transducer 116 receives and converts acoustic waves 117 to an electrical signal and provides the electrical signal to receive amplifier 114 for amplification, among other processing. Receive amplifier 114 processes the electrical signal and provides a processed electrical signal to control circuit 118. Control circuit 118 then generates a detection signal 125 based on the processed electrical signal. Detection signal 125 may indicate, for example, a detection of object 120, a distance between object 120 and packaged integrated circuit 100, or other information.

In various examples, control circuit 118 directs transmit driver 110 to generate the electrical signal at the second resonant frequency. In this way, transmit driver 110 excites transmit acoustic transducer 112 at the resonant frequency of receive acoustic transducer 116 as opposed to the resonant frequency of transmit acoustic transducer 112. To improve sensitivity of echo signals by receive acoustic transducer 116, control circuit 118 can direct transmit driver 110 to generate the electrical signal with an amplitude sufficient to saturate transmit acoustic transducer 112 (e.g., causing the transducer to vibrate at a maximum amplitude) such that the acoustic waves generated by transmit acoustic transducer 112 can generate a pressure similar to when transmit acoustic transducer 112 is excited at its resonant frequency.

As a result of exciting transmit acoustic transducer 112 at the second resonant frequency, acoustic waves 117 received by receive acoustic transducer 116 may have the second resonant frequency aligning with the resonant frequency of receive acoustic transducer 116. Advantageously, the sensitivity of receive acoustic transducer 116 may be improved as it operates most effectively and efficiently at the second resonant frequency, which in turn, may improve detection accuracy of packaged integrated circuit 100.

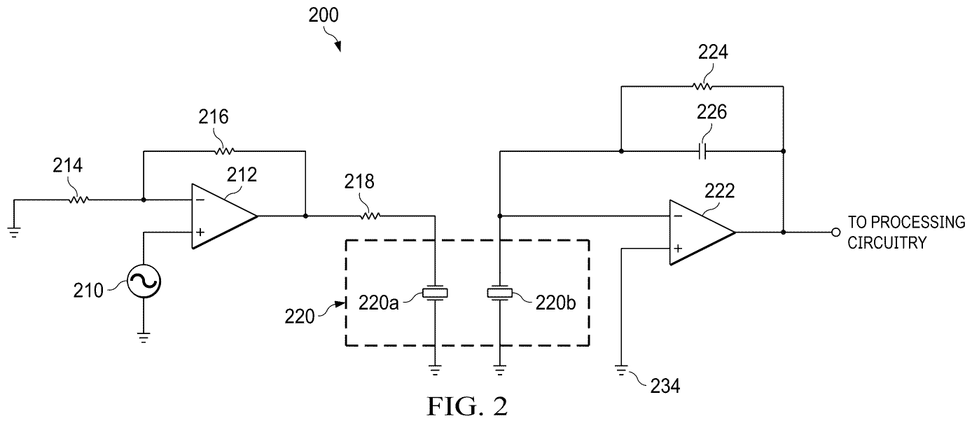

FIG. 2 illustrates an example circuit in an implementation. FIG. 2 shows circuit 200, which is representative of various elements of packaged integrated circuit 100 of FIG. 1. In particular, circuit 200 includes an amplifier 212, a bistatic sensor system 220, and an amplifier 222, as well as various other electronic elements, such as resistors 214, 216, 218, and 224, and capacitor 226. Circuit 200 may be included and at least partially covered by a package material, forming packaged integrated circuit 100.

In various examples, bistatic sensor 220 includes a transmit acoustic transducer 220a (e.g., transmit acoustic transducer 112) and a receive acoustic transducer 220b (e.g., receive acoustic transducer 116) co-located on a single chip or in an integrated circuit (IC) package. The transmit acoustic transducer of bistatic sensor 220 is provided an electrical signal by amplifier 212, and the receive acoustic transducer of bistatic sensor package 220 outputs an electrical signal to amplifier 222.

Amplifier 212 may be part of a driver for transmit acoustic transducer 220a of bistatic sensor 220, such as transmit driver 110 of FIGS. 1A and 1B. Amplifier 212 may be an operational amplifier (opamp) having a non-inverting configuration. Amplifier 212 has a feedback network comprising resistors 214 and 216, where resistor 214 is coupled between a ground and the negative input of amplifier 212, and resistor 216 is coupled between the negative input and the output of amplifier 212. Resistor 218 is coupled between the output of amplifier 212 and an electrode of transducer 220a, while the other electrode of transducer 220a is coupled to ground. The positive input of amplifier 212 is coupled to a signal generator 210, which can be part of a control circuit (e.g., control circuit 118). Signal generator 210 can generate a voltage signal at the resonant frequency of receive acoustic transducer 220b. Amplifier 212 can amplify the voltage signal to, for example, an amplitude that can saturate transmit acoustic transducer 220a, and drive transmit acoustic transducer 220a with the amplified voltage signal.

Amplifier 222 may be part of an amplifier for receive acoustic transducer 220b of bistatic sensor 220, such as receive amplifier 114 or AFE of FIGS. 1A and 1B. Amplifier 222 may be an operational amplifier (opamp) having an inverting configuration. Amplifier 222 has a feedback network comprising capacitor 224 and resistor 226 coupled between the negative input and the output of amplifier 222. The negative input is coupled to an electrode of receive acoustic transducer 220b, and the positive input of amplifier 222 is coupled to ground. In operation, receive acoustic transducer 220b can detect an acoustic wave (e.g., acoustic wave 117 of FIG. 1B) and convert the acoustic wave into a voltage signal. Amplifier 222 can amplify the voltage signal, and the feedback network comprising capacitor 224 and resistor 226 can provide low pass filtering to the amplified voltage signal. Processing circuitry, such as control circuit 118, can process the filtered amplified voltage signal to generate detection signal 125.

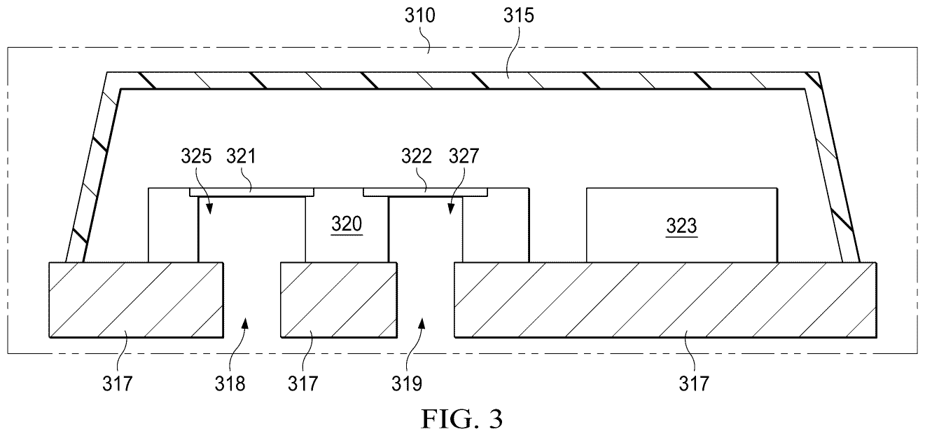

FIG. 3 illustrates an example of a bistatic sensor package 310, which can be an example of packaged integrated circuit 100 of FIG. 1. As shown in FIG. 3, bistatic sensor package 310 may include a housing 315, a package substrate 317, a semiconductor substrate 320, acoustic transducers 321 and 322, and circuitry 323. Circuitry 323 may include one or more of an analog front end (AFE) including transmit driver 110 and a receive amplifier 114, control circuit 118, etc.

In various examples, bistatic sensor package 310 is representative of a device that includes a bistatic sensor, driver circuitry (e.g., transmit driver 110, amplifier 212, receive amplifier 114, amplifier 222) coupled to the bistatic sensor, control circuitry (e.g., control circuit 118) coupled to the driver circuitry, and package material that covers at least part of the bistatic sensor, driver circuitry, and control circuitry. Bistatic sensor package 310 may be configurable to transmit and receive acoustic signals to and from, respectively, an object and detect characteristics of the object based on processing the received acoustic signals. To do so, bistatic sensor package 310 includes transmit acoustic transducer 321 and receive acoustic transducer 322, which together form the bistatic sensor, and circuitry 323. While not shown, bistatic sensor package 310 may additionally include control circuitry, such as control circuit 118 of FIGS. 1A and 1B.

In the configuration shown in FIG. 3, bistatic sensor package 310 includes a housing 315 and a package substrate 317 that forms the package material that, at least partially, covers transmit acoustic transducer 321, a receive acoustic transducer 322, and circuitry 323, among other elements. Housing 315 may include a metal housing or a Package substrate 317 may include, for example, a laminate of multiple layers of a dielectric material (e.g., Ajinomoto build-up film (ABF), epoxy, etc.), a ceramic substrate, a lead frame, or other materials.

In various examples, semiconductor substrate 320 is representative of a substrate on which transmit acoustic transducer 321 and receive acoustic transducer 322 are formed or otherwise are affixed. Semiconductor substrate 320 may include silicon. As illustrated in FIG. 3, substrate 320 includes two recesses 325 and 327. Transmit acoustic transducer 321 is exposed in recess 325, and receive acoustic transducer 322 is exposed in recess 327. In the example of FIG. 3, each of transmit acoustic transducer 321 and receive acoustic transducer 322 can be a PMUT and includes a piezoelectric layer sandwiched between a top electrode and a bottom electrode (not shown in FIG. 3). The piezoelectric layer of transmit acoustic transducer 321 can vibrate responsive to a voltage signal across the top and bottom electrodes to generate acoustic waves. Also, the piezoelectric layer of receive acoustic transducer 322 can vibrate responsive to acoustic waves and generate a voltage signal across the top and bottom electrodes. In other examples, each of transmit acoustic transducer 321 and receive acoustic transducer 322 can be a CMUT and includes a membrane and a cavity sandwiched between a top electrode and a bottom electrode.

The acoustic waves generated by transmit acoustic transducer 321 can propagate out of recess 325, and receive acoustic transducer 322 can receive acoustic waves via recess 327. The dimensions of recesses 325 and 327, the spacing between the two recesses, the dimensions and thicknesses of transmit acoustic transducer 321 and receive acoustic transducer 322 exposed in the recesses, and the spacing between transmit acoustic transducer 321 and receive acoustic transducer 322, may be selected/configured to set the respective resonant frequencies of transmit acoustic transducer 321 and receive acoustic transducer 322 and based on desired performance of transmit acoustic transducer 321 and receive acoustic transducer 322.

In various examples, housing 315 includes a hollow metal housing in which substrate 320, transmit acoustic transducer 321, receive acoustic transducer 322, and AFE 323 are positioned and covered on at least three sides. In some examples, housing 315 is not hollow, but is filled with material that keeps substrate 320, transmit acoustic transducer 321, receive acoustic transducer 322, and circuitry 323 in place. Examples of such a material include an epoxy, a gel, a dielectric material, a molding compound, a resin, or other materials. In some examples, housing 315 may include one or more other materials, a different shape, and/or other dimensions, as well as combinations and variations thereof.

Package substrate 317 is affixed to an otherwise open side of housing 315, and semiconductor substrate 320 (with, transmit acoustic transducer 321 and receive acoustic transducer 322) and circuitry 323 are mounted on package substrate 317. In various examples, package substrate 317 is representative of a lead frame or a laminate including one or more dielectric layers, however, other materials of varying dimensions and shapes can be contemplated.

Package substrate 317 may be mounted on a circuit board (e.g., a printed circuit board) and may include metal interconnects to provide electrical connection between the circuit board and circuitry 323 and between circuitry 323 and each of transmit acoustic transducer 321 and receive acoustic transducer 322. Package substrate 317 may also include two through openings 318 and 319 which align with, respectively, recesses 325 and 327. In examples where transmit acoustic transducer 321 and receive acoustic transducer 322 are CMUTs, the membranes of the transducers are exposed in openings 318 and 319. Accordingly, acoustic waves generated by transmit transducer 321 can propagate through recess 325 and opening 318 and exit bistatic sensor package 310. Also, acoustic waves (e.g., echo signals) can enter bistatic sensor package 310 via opening 319 and recess 327 and reach receive acoustic transducer 322. The shapes and sizes of openings may also be selected based on the resonant frequencies of transmit acoustic transducer 321 and receive acoustic transducer 322, respectively, as well as the desired performance of transmit acoustic transducer 321 and receive acoustic transducer 322.

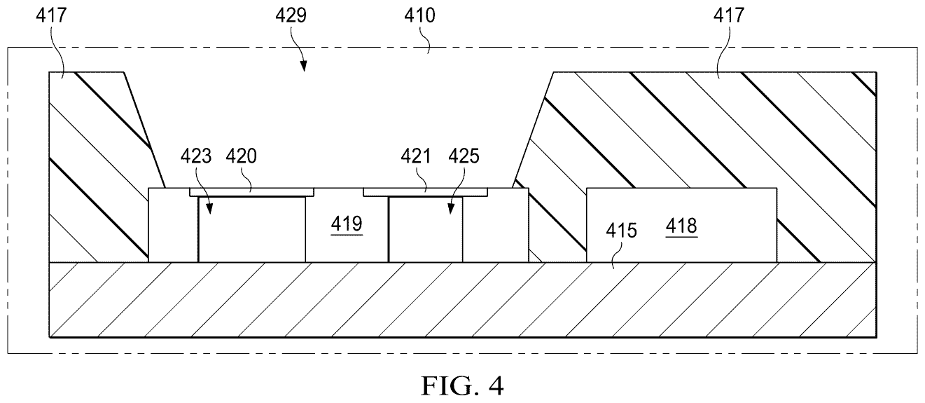

FIG. 4 illustrates an example of a bistatic sensor package 410, which can be an example of packaged integrated circuit 100 of FIGS. 1A and 1B. As shown in FIG. 4, bistatic sensor package 410 may include a molding compound 417, a package substrate 415, a semiconductor substrate 419, acoustic transducers 420 and 421 formed on semiconductor substrate 419, and circuitry 418. Circuitry 418 may include one or more of an analog front end (AFE) including transmit driver 110 and a receive amplifier 114, control circuit 118, etc.

In various examples, bistatic sensor package 410 is representative of a packaged integrated circuit that includes a bistatic sensor, driver circuitry (e.g., transmit driver 110, amplifier 212, receive amplifier 114, amplifier 222) coupled to the bistatic sensor, control circuitry (e.g., control circuit 118) coupled to the driver circuitry, and a package material that covers at least part of the bistatic sensor, driver circuitry, and control circuitry. Bistatic sensor package 410 may be configurable to transmit and receive acoustic signals to and from, respectively, an object and detect characteristics of the object based on processing the received acoustic signals. To do so, bistatic sensor package 410 includes transmit acoustic transducer 420 and receive acoustic transducer 421, which together form the bistatic sensor, and circuitry 418. In the example of FIG. 4, each of transmit acoustic transducer 420 and receive acoustic transducer 421 can be a PMUT. In the configuration shown in FIG. 4, bistatic sensor package 410 includes molding compound 417 and package substrate 415 forming the package material that, at least partially, covers transmit acoustic transducer 420, receive acoustic transducer 421, and circuitry 418, among other elements.

In various examples, semiconductor substrate 419 is representative of a substrate on which transmit acoustic transducer 420 and receive acoustic transducer 421 are formed or otherwise affixed to. Substrate 419 may include silicon and may be similar to semiconductor substrate 320 of FIG. 3.

As illustrated in FIG. 4, semiconductor substrate 419 includes two recesses 423 and 425. Transmit acoustic transducer 420 is exposed in recess 423, and receive acoustic transducer 421 is exposed in recess 425. The recesses allow transmit acoustic transducer 420 and receive acoustic transducer 421 to be released and capable of vibrating. The dimensions of the two cavities, the spacing between the two recesses, the dimensions of transmit acoustic transducer 420 and receive acoustic transducer 421, and the spacing between transmit acoustic transducer 420 and receive acoustic transducer 421 may be selected based on the resonant frequencies of transmit acoustic transducer 420 and receive acoustic transducer 421 and based on desired performance of transmit acoustic transducer 420 and receive acoustic transducer 421.

In various examples, molding compound 417 can include a thermosetting material to at least partially encapsulate/cover semiconductor substrate 419, transmit acoustic transducer 420, receive acoustic transducer 421, and circuitry 418 on at least three sides. More particularly, in some such examples, circuitry 418 may be fully enclosed within molding compound 417, while semiconductor substrate 419 substrate may be partially covered by molding compound 417. Molding compound 417 can include a through opening 429 in which transmit acoustic transducer 420 and receive acoustic transducer 421 are exposed. Acoustic waves transmitted by transmit acoustic transducer 420 or to be detected by receive acoustic transducer 421 can propagate through opening 429. In some examples, molding compound 417 may include be made of and include one or more other materials, a different shape, and/or other dimensions, as well as combinations and variations thereof.

Semiconductor substrate 419 and circuitry 418 are mounted on package substrate 417, and molding compound 417 is formed on package substrate 417. Package substrate 417 may be mounted on a circuit board (e.g., a printed circuit board) and may include metal interconnects to provide electrical connection between the circuit board and circuitry 418 and between circuitry 418 and each of transmit acoustic transducer 420 and receive acoustic transducer 421. Package substrate 417 may include, for example, a laminate of multiple dielectric layers, a ceramic substrate, or a lead frame.

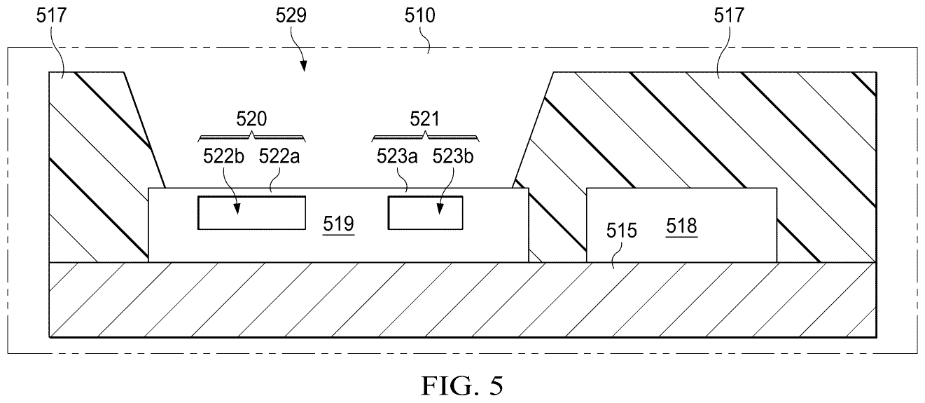

FIG. 5 illustrates an example of a bistatic sensor package 510, which can be an example of packaged integrated circuit 100 of FIGS. 1A and 1B. As shown in FIG. 5, bistatic sensor package 510 may include a molding compound 517, a package substrate 515, a semiconductor substrate 519, acoustic transducers 520 and 521 formed on semiconductor substrate 519, and circuitry 518. Circuitry 518 may include one or more of an analog front end (AFE) including transmit driver 110 and receive amplifier 114, control circuit 118, etc.

In various examples, bistatic sensor package 510 is representative of a packaged integrated circuit that includes a bistatic sensor, driver circuitry (e.g., transmit driver 110, amplifier 212, receive amplifier 114, amplifier 222) coupled to the bistatic sensor, control circuitry (e.g., control circuit 118) coupled to the driver circuitry, and a package material that covers at least part of the bistatic sensor, driver circuitry, and control circuitry. Bistatic sensor package 510 may be configurable to transmit and receive acoustic signals to and from, respectively, an object and detect characteristics of the object based on processing the received acoustic signals. To do so, bistatic sensor package 510 includes transmit acoustic transducer 520 and receive acoustic transducer 521, which together form the bistatic sensor, and circuitry 518.

In the example of FIG. 5, each of transmit acoustic transducer 520 and receive acoustic transducer 521 can be a CMUT. Transmit acoustic transducer 520 includes a membrane 522a and cavity 522b sandwiched between a top electrode and a bottom electrode (not shown in FIG. 5), and receive acoustic transducer 521 includes a membrane 523a and cavity 523b between a top electrode and a bottom electrode (not shown in FIG. 5). Membrane 522a of transmit acoustic transducer 520 can vibrate in cavity 522b to generate acoustic waves responsive to an electrostatic force between the top and bottom electrodes when a voltage signal is applied across the top and bottom electrodes. Also, membrane 523a of receive acoustic transducer 521 can vibrate in cavity 523b responsive to acoustic waves, causing electrical charge to flow in and out of the top electrode and generate a current.

In the configuration shown in FIG. 5, bistatic sensor package 510 includes molding compound 517 and package substrate 515 forming the package material that, at least partially, covers transmit acoustic transducer 520, receive acoustic transducer 521, and circuitry 518, among other elements. In various examples, molding compound 517 can include a thermosetting material to at least partially encapsulate/cover semiconductor substrate 519, transmit acoustic transducer 420, receive acoustic transducer 521, and circuitry 518 on at least three sides. More particularly, in some such examples, circuitry 518 may be fully enclosed within molding compound 517, while semiconductor substrate 519 substrate may be partially covered by molding compound 517. Molding compound 517 can include a through opening 529 in which transmit acoustic transducer 520 and receive acoustic transducer 521 are exposed. Acoustic waves transmitted by transmit acoustic transducer 520 or to be detected by receive acoustic transducer 521 can propagate through opening 529. In some examples, molding compound 517 may include be made of and include one or more other materials, a different shape, and/or other dimensions, as well as combinations and variations thereof.

Semiconductor substrate 519 and circuitry 518 are mounted on package substrate 517, and molding compound 517 is formed on package substrate 517. Package substrate 517 may be mounted on a circuit board (e.g., a printed circuit board) and may include metal interconnects to provide electrical connection between the circuit board and circuitry 518 and between circuitry 518 and each of transmit acoustic transducer 520 and receive acoustic transducer 521. Package substrate 517 may include, for example, a laminate of multiple dielectric layers, a ceramic substrate, or a lead frame.

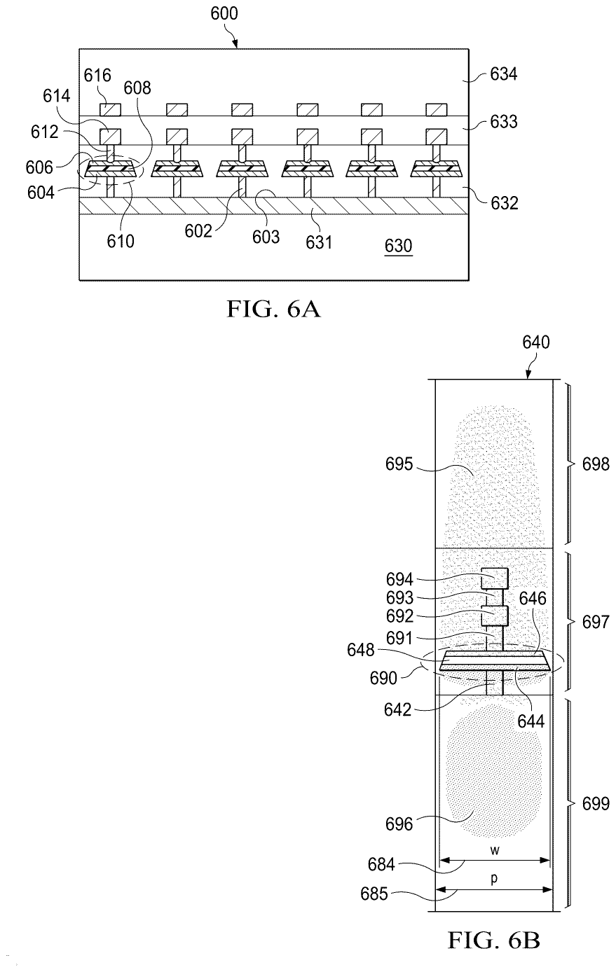

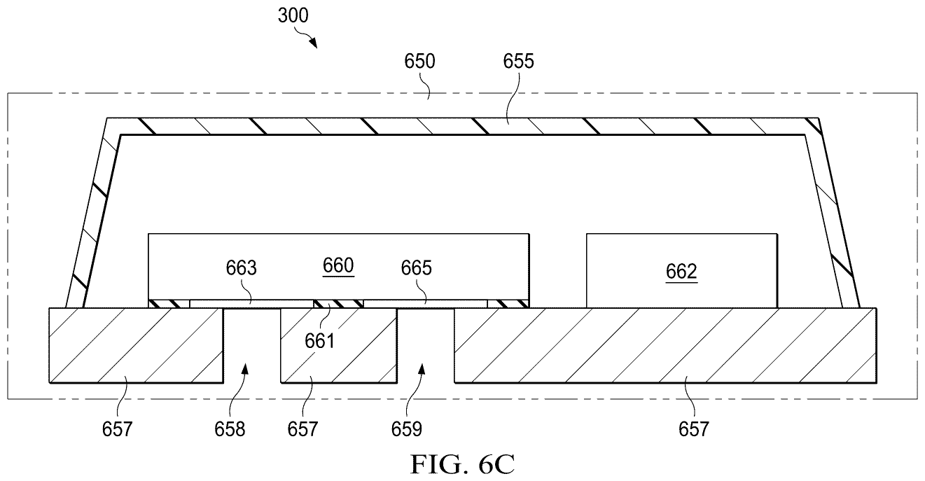

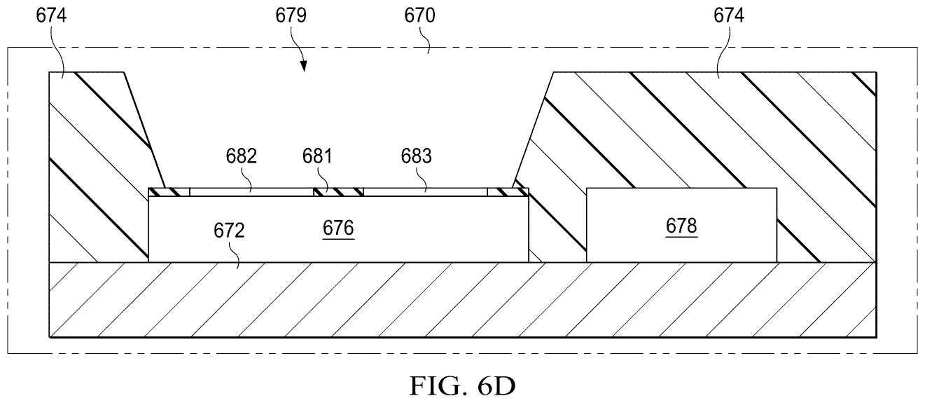

FIGS. 6A, 6B, 6C, and 6D illustrate an example of a bistatic sensor package 650 and its components, which can be an example of packaged integrated circuit 100 of FIGS. 1A and 1B.

Referring first to FIG. 6A, FIG. 6A shows a side cross-sectional view of a portion of an integrated circuit 600 (e.g., a CMOS IC), which includes one or more ferroelectric capacitors, or FeCaps, such as FeCap 610. FeCap 610 is representative of a linear array of FeCaps that is included in IC 600. FeCap 610 has a bottom plate 604 and a top plate 606 patterned from a conductive layer. Ferroelectric lead zirconate titanate (PZT) material 608 is sandwiched between lower plate 604 and upper plate 606 to form a capacitor configuration. Via 602 connects a conductive signal line 603 to lower plate 604. Via 612 connects a contact 614 and thereby a conductive signal line 615 in a first metal layer to upper plate 106. A contact 616 in a second metal layer provides an additional signal routing layer that is interconnected with vias (not shown) to signal lines in the first metal layer.

A linear array of FeCaps 610 is formed along an axis 620. Each FeCap 610 has a width (w) 624 and a length (L) 622. The linear array of FeCaps is arranged to have a pitch (p) 625. The array of FeCaps is arranged such that the length 622 of each FeCap 610 is perpendicular to the axis 620. The respective width and pitch of the FeCaps in the linear array are selected to produce an ultrasonic wave in a central portion of the linear array, prevent the ultrasonic wave from dispersing from one end of the linear array, and to cause the ultrasonic wave to “leak” or disperse from the other end of the linear array to thereby from an ultrasonic transmitter. In this example, the length L is 10 μm. In another example L may be larger or smaller for corresponding signal strength. The pitch of the FeCap can set a resonant frequency.

Substrate 630 is bulk silicon in this example. On top of the substrate 630 n+ and p+ wells are formed, providing a region for CMOS transistors implantation. FeCaps 610 are also formed on N-well layer 631 using known or later developed fabrication techniques during the FEOL processing of integrated circuit 600. Contacts 614, 616 and vias 612 are formed during processing of integrated circuit 600 using known or later developed fabrication techniques. In this example, silicon dioxide layers 632, 633, 634 provide electrical insulation around and between the first and second metal layers and contacts such as contacts 614, 616. In other examples, various types of known or later developed interconnect dielectric layers may be used between multiple metal layers.

FeCaps 610 are fabricated during the FEOL processing of integrated circuit 600 using known or later developed fabrication techniques. A first conductive layer that forms the bottom plates 604 may be deposited on substrate 630. The ferroelectric layer that forms the FeCap is then deposited over the first conductive layer. A second conductive layer is then deposited over the ferroelectric layer. An etch process is then performed to form the individual plates of the linear array of FeCaps. In another example, each layer may be patterned and etched individually. The first and second conductive layers that form the plates of the linear array of FeCaps are a metallic alloy in this example.

FIG. 6B shows a cross-sectional view of a single FeCap 610 and simulated electric fields surrounding the FeCap. In order to better understand the operation of ultrasonic transducers based on FeCaps, simulations are performed on a structure similar to FeCap 610 of FIG. 6A using a numerical finite element method (FEM) simulation tool.

In this example, simulation unit cell 690 includes a region 697 of FeCap 610 that includes a lower plate 644, an upper plate 646, a PZT layer 648, and an via 642. Region 697 also includes vias 691, 693 and contacts 692, 694. Region 697 also includes dielectric layers that surround the vias and contacts, such as layers 632, 633, 634 of FIG. 6A. A regular IC passivation process for the selected CMOS process is assumed at the end (silicon dioxide, silicon nitride, etc.). FeCap 610 has a width 684 and a pitch 685 for adjacent FeCaps. For this simulation, the length of FeCap 610 is perpendicular to the view and is considered to be infinite into and out of the plane of the view.

Regions 698, 699 represent “perfectly matched layers” (PML) that are added to allow the simulated behavior of ultrasonic radiation produced by FeCap 610 to be studied in an assumed infinitely extended plane. PMLs 698, 699 have respective simulated properties that match the region of 697 to which they are adjacent. In this example, PML 698 matches the dielectric of region 697 above FeCap 610, while PML 699 matches the silicon substrate below FeCap 610.

Since the goal is to simulate a resonator, a wave on the left side must be related to a wave on right side with a constant phase shift. Thus, the wave vector times separation (pitch 685) must be a constant value. Multiple eigen-frequency simulations are performed to find out all the possible propagating modes in the structure, given a constant phase shift. Various traveling and evanescent waves are formed depending on the phase shift, frequency, and material properties. An evanescent field, or evanescent wave, is an oscillating field that does not propagate but whose energy is spatially concentrated in the vicinity of the source. Shaded regions 695, 696 illustrate an evanescent field. The simulated results may be illustrated by a dispersion plot.

Additional information related to FeCaps, and their structure and operation can be found in Applicant's related application Ser. No. 17/860,087, published as U.S. 2022/0345228 A1, entitled “HIGH FREQUENCY CMOS ULTRASONIC TRANSDUCER,” filed on Jul. 7, 2022, which is hereby incorporated by reference in its entirety.

Referring next to FIG. 6C, FIG. 6C shows a bistatic sensor package 650, which includes a housing 655, a package substrate 657, a semiconductor substrate 660, a dielectric layer 661 on semiconductor substrate 660, and circuitry 662. Package substrate 657 includes an opening 658 and an opening 659. Bistatic sensor package 650 can be an example of packaged integrated circuit 100 of FIGS. 1A and 1B. A transmit acoustic transducer 663 can be formed in dielectric layer 661 and exposed in opening 658, and a receive acoustic transducer 665 can be formed also in dielectric layer 661 and exposed in opening 659. Each of transmit acoustic transducer 663 and receive acoustic transducer 665 can include one or more FeCaps similar to the ones shown above in FIGS. 6A and 6B. The FeCaps of transmit acoustic transducer 663 and receive acoustic transducer 665 can have different pitches so that the transducers have different resonant frequencies. Housing 655, package substrate 657, and circuitry 662 may be similar to, respectively, housing 315, package substrate 317, and circuitry 323 of FIG. 3.

FIG. 6D shows a bistatic sensor package 670, which can be an example of packaged integrated circuit 100 of FIGS. 1A and 1B. As shown in FIG. 6D, bistatic sensor package 670 may include a molding compound 674, a package substrate 672, a semiconductor substrate 676, a dielectric layer 681 on semiconductor substrate 676, and circuitry 678. Molding compound 674 can include an opening 679. A transmit acoustic transducer 682 and a receive acoustic transducer 683 can be formed in dielectric layer 681 and exposed in opening 679. Each of transmit acoustic transducer 682 and receive acoustic transducer 683 can include one or more FeCaps similar to the ones shown above in FIGS. 6A and 6B. The FeCaps of transmit acoustic transducer 682 and receive acoustic transducer 683 can have different pitches so that the transducers have different resonant frequencies. Molding compound 674, package substrate 672, and circuitry 678 can be similar to, respectively, molding compound 517, package substrate 515, and circuitry 523 of FIG. 5.

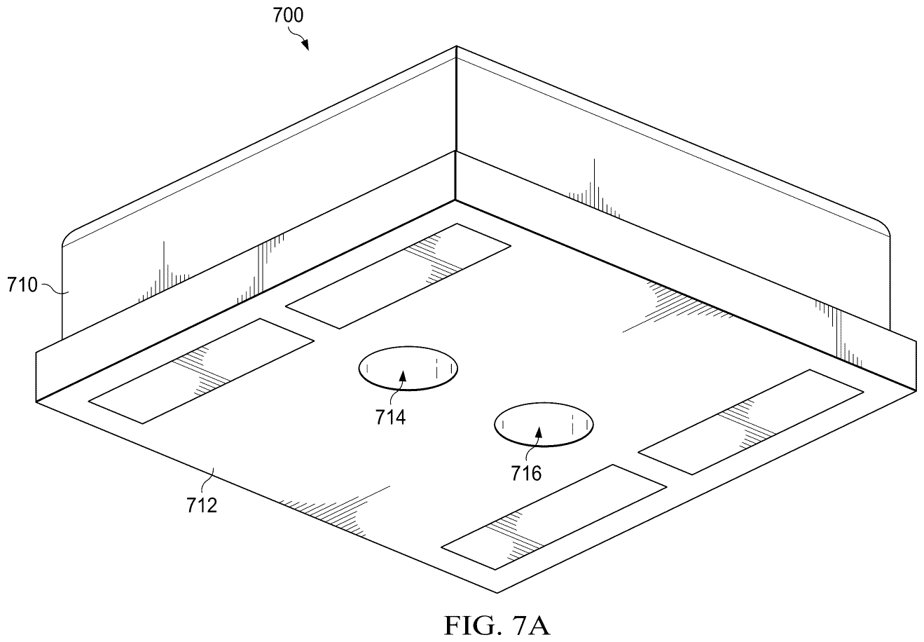

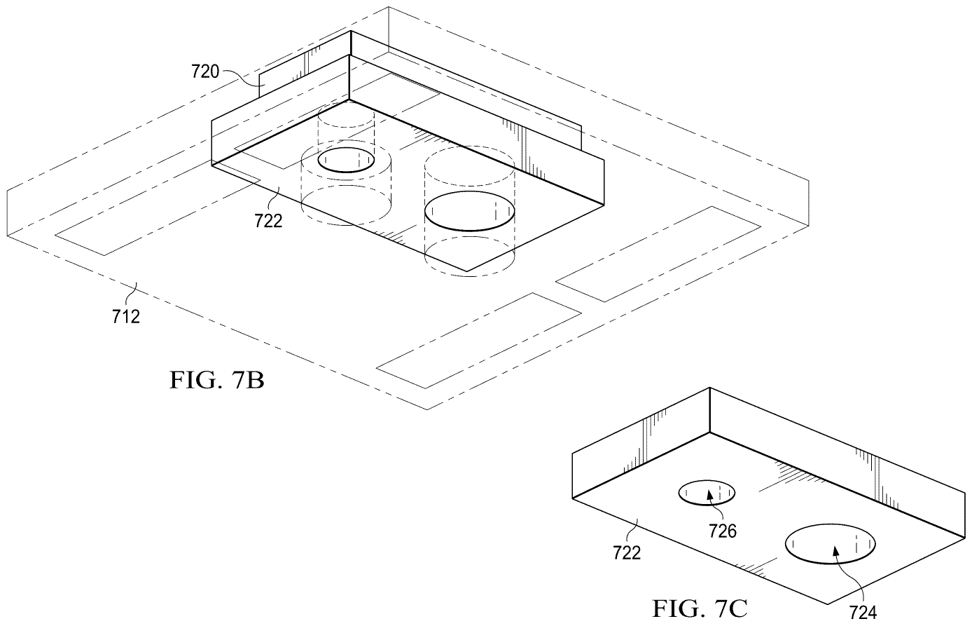

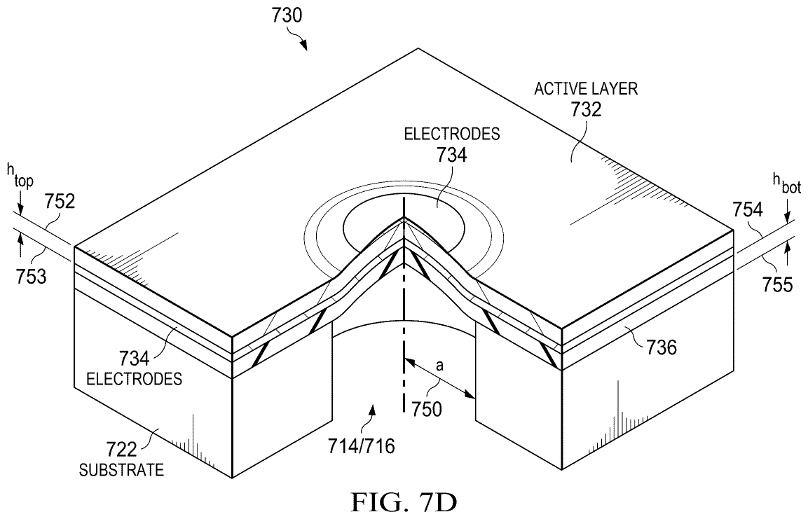

FIGS. 7A, 7B, 7C, and 7D illustrate an example of a packaged integrated circuit 700 and its components, which can be an example of packaged integrated circuit 100 of FIGS. 1A and 1B. FIG. 7A shows an isometric view of an exterior of a packaged integrated circuit, such as packaged integrated circuit 100 of FIGS. 1A and 1B and bistatic sensor package 220 of FIG. 2. More specifically, FIG. 7A includes packaged integrated circuit 700 and shows a housing 710 and package substrate 712 thereof. Package substrate 712 includes openings 714 and 716. Housing 710 and package substrate 712 can be similar to, for example, housing 315 and package substrate 317 of FIG. 3. FIG. 7B shows an isometric view of package substrate 712, semiconductor substrate 722, and circuitry 720 of packaged integrated circuit 700. Semiconductor substrate 722 and circuitry 720 can be similar to semiconductor substrate 320 and circuitry 323 of FIG. 3. FIG. 7C shows an isometric view of semiconductor substrate 722 of packaged integrated circuit 700, where semiconductor substrate 722 include openings 724 and 726 aligned with, respectively, openings 714 and 716 of package substrate 712. FIG. 7D shows a cross-section view of an acoustic transducer 730 of packaged integrated circuit 700, which can be a PMUT or a CMUT and includes a top electrode 734a and a bottom electrode 734b, an active layer 732 between electrodes 734a and 734b, and a passivation layer 736 on semiconductor substrate 722 and over one of openings 714/716.

Referring first to FIG. 7A, in various examples, packaged integrated circuit 700 is representative of a device including various electronic, electrical, and hardware components, including a bistatic sensor, integrated into a single package covered, at least partially, by a package material (e.g., a metal material, a plastic material). Some elements of packaged integrated circuit 700, such as the bistatic sensor (e.g., including acoustic transducer 730) and associated control circuitry, may be configurable to perform ultrasonic sensing operations, digital signal processing operations, object detection operations, and the like, as described herein. Some elements of packaged integrated circuit 700, such as housing 710 and package substrate 712, representative of a housing and package substrate such as housing 315 and package substrate 317 of FIG. 3, provide protection for the bistatic sensor and associated control circuitry.

Moving next to FIG. 7B, FIG. 7B includes a different view of package substrate 712 in which package substrate 712 is shown transparently to illustrate the positioning of semiconductor substrate 722 (which may be an example of semiconductor substrate 320) and circuitry 720 (e.g., one or more of an AFE, transmit driver, receive amplifier such as ones described above) relative to package substrate 712. As shown in FIG. 7B, semiconductor substrate 722 and circuitry 720 are positioned on a side of package substrate 712 such that semiconductor substrate 722 and circuitry 720 are located inside housing 710 (shown in FIG. 7A). In some examples, both semiconductor substrate 722 and circuitry 720 are affixed to this side of package substrate 712. In some examples, semiconductor substrate 722 is affixed to this side of package substrate 712, and circuitry 720 is affixed to substrate 722.

Referring next to FIG. 7C, FIG. 7C shows a view of semiconductor substrate 722 and openings 724 and 726 of semiconductor substrate 722. Openings 724 and 726 penetrate the material(s) of substrate 722, providing an opening to the elements inside housing 710. In particular, as can be seen in FIG. 7B, opening 726 aligns with opening 714 of package substrate 712, and opening 724 aligns with opening 716 of package substrate 712, such that there are openings through package substrate 712 and semiconductor substrate 722 to an external environment via openings 714 and 726 and via openings 716 and 724. Like openings 714 and 716, the shapes and sizes of openings 724 and 726 may be selected based on the resonant frequencies of the transducers as well as the desired performance of the bistatic sensor of packaged integrated circuit 700.

FIG. 7D shows a cross-section view of acoustic transducer 730, which is representative of an example acoustic transducer that forms a bistatic sensor along with another acoustic transducer (not shown). Acoustic transducer 730 includes various layers and materials, such as active layer 732, electrodes 734, and passive layer 736, which may each contribute to transmission or reception capabilities of acoustic transducer 730. In some examples, acoustic transducer 730 is affixed to or coupled to a side of semiconductor substrate 722 such that acoustic transducer 730 is positioned internally within housing 710. In particular, passive layer 736 may be coupled to a portion of semiconductor substrate 722, electrodes 734 may be coupled to passive layer 736, and active layer 732 may be coupled to electrodes 734. In some examples, acoustic transducer 730 is, at least partially, embedded in semiconductor substrate 722. In some such examples, a portion of semiconductor substrate 722 may surround one or more of active layer 732, electrodes 734, and passive layer 736.

By way of a first example in which acoustic transducer 730 includes a capacitive micromachined ultrasonic transducer (CMUT), active layer 732 is representative of a flexible membrane (e.g., silicon nitride, polysilicon) that can vibrate in response to an applied electric field (if acoustic transducer 730 is used as a transmitter) or in response to incoming acoustic waves (if acoustic transducer 730 is used as a receiver). If acoustic transducer 730 is used as a transmitter, a voltage applied to active layer 732 and to electrodes 734 (e.g., by TX driver 110) cause active layer 732 to vibrate, generating acoustic waves. If acoustic transducer 730 is used as a receiver, incoming acoustic waves cause a deflection in active layer 732, changing the capacitance between active layer 732 and electrodes 734 and generating a measurable electrical signal (e.g., by RX amplifier 114). In some such examples where acoustic transducer 730 includes a CMUT and utilizes one or more ferroelectric capacitors (FeCaps, e.g., FeCap 610), electrodes 734 may remain stationary as active layer 732 vibrates upon receiving an electrical signal.

By way of a second example in which acoustic transducer 730 includes a piezoelectric micromachined ultrasonic transducer (PMUT), active layer 732, electrodes 734, and passive layer 736 may operate differently. In such an example, active layer 732 is representative of a piezoelectric film (e.g., PZT, AIN, PVDF) that can deform and vibrate when subjected to an electric field or mechanical stress allowing conversion of electrical signals to mechanical vibrations (and vice versa) through its piezoelectric properties. For example, if acoustic transducer 730 is used as a transmitter, a voltage applied to active layer 732 and to electrodes 734 (e.g., by TX driver 110) causes active layer 732 to deform, generating acoustic waves. If acoustic transducer 730 is used as a receiver, incoming acoustic waves induce mechanical stress in active layer 732, generating a voltage across electrodes 734 and received by RX amplifier 114.

In both examples, passive layer 736 may be representative of an insulating layer (e.g., silicon, silicon dioxide, nitride) that supports electrodes 734 and provides structural support, acoustic impedance matching, insulation, and geometrical support for acoustic transducer 730. Passive layer 736 thus does not actively participate in a transduction process, but rather prevents electrical shorting between electrodes 734, reduces unwanted reflections within acoustic transducer 730, and facilitates energy transfer to improve efficiency of acoustic transducer 730.

As illustrated in FIG. 7D, a portion of active layer 732, electrodes 734, and passive layer 736 is positioned within opening 726 of semiconductor substrate 722. As mentioned above, opening 726, along with opening 714, provides an opening through which acoustic transducer 730 can emit acoustic waves or receive acoustic waves. The dimensions of opening 726, such as opening radius 750, and the dimensions of active layer 732 (e.g., thickness, defined by heights 752 and 753), electrodes 734, and passive layer 736 (e.g., thickness, defined by heights 754 and 755) may be selected based on the resonant frequency of acoustic transducer 730. In various examples, a portion of electrodes 734 located on active layer 732 is centered within opening 726. More particularly, in some examples, the length or width of active layer 732, electrodes 734, and/or passive layer 736 may extend across the diameter of opening 726.

While only one acoustic transducer and elements thereof are shown in FIG. 7D, it may be appreciated that packaged integrated circuit 700 includes a second acoustic transducer coupled to or embedded in semiconductor substrate 722 in alignment with opening 724 so as to form a bistatic sensor. Other dimensions, shapes, and the like of any of the elements of packaged integrated circuit 700 may be contemplated but are excluded for the sake of simplicity and brevity.

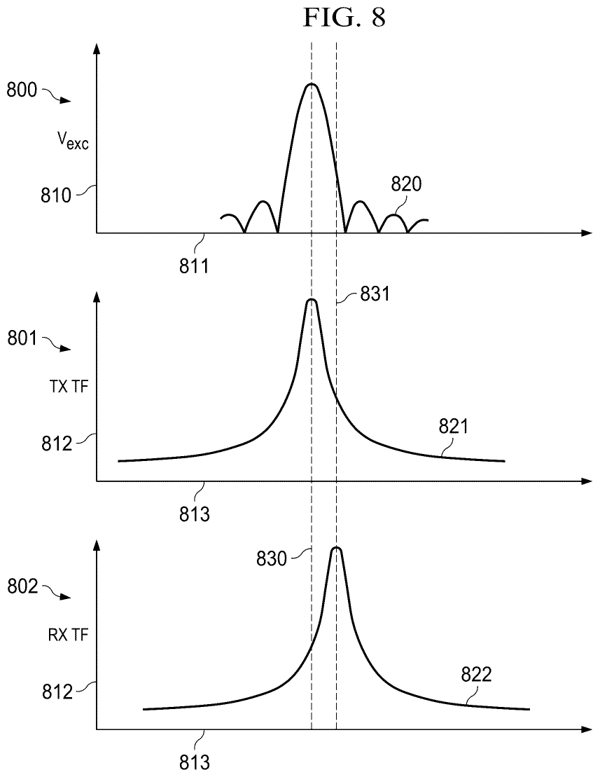

FIG. 8 includes graphs that illustrate the effect of resonant frequency mismatches between transmit and receive acoustic transducers on the operation of a bistatic sensor. In FIG. 8, both transmit and receive acoustic transducers are designed and assumed to have a same resonant frequency, and the transmit acoustic transducer is driven at its resonant frequency. FIG. 8 shows graphical representations 800, 801, and 802, which show waveforms 820, 821, and 822, respectively.

Referring first to waveform 820 of graphical representation 800, waveform 820 represents a signal (e.g., signal 210) provided to a transmit acoustic transducer (e.g., transmit acoustic transducer 321) by a driver (e.g., transmit driver 110). The signal includes values with respect to voltage 810 and frequency 811. More particularly, the signal represents an excitation voltage having a peak amplitude with respect to voltage 810 at frequency 830, which is the resonant frequency of the transmit acoustic transducer and is also assumed to be the resonant frequency of the receive acoustic transducer.

In an operational example, when a transmit acoustic transducer receives this signal, the transmit acoustic transducer is excited at frequency 830, causing the transmit acoustic transducer to produce acoustic waves resonating at frequency 830. The efficiency and intensity at which the transmit acoustic transducer produces the acoustic waves depends on the resonant frequency of the transmit acoustic transducer shown and described next with respect to graphical representation 801.

Referring next to waveform 821 of graphical representation 801, waveform 821 represents a resonance transfer function of a transmit acoustic transducer (e.g., transmit acoustic transducer 321) with respect to voltage 810 and frequency 811. In other words, waveform 821 shows a 3 dB frequency band of the transmit acoustic transducer and a resonant frequency at which the transmit acoustic transducer is excitable at maximum efficiency. In graphical representation 801, the resonant frequency of the transmit acoustic transducer includes frequency 830, while the frequency band of transmit acoustic transducer includes frequency 830 and a frequency 831, among other frequencies.

Following the operational example above, when the transmit acoustic transducer receives the signal represented by waveform 820, the transmit acoustic transducer may operate at maximum efficiency as the signal and the resonant frequency of the transmit acoustic transducer are the same. The efficiency at which a receive acoustic transducer (e.g., receive acoustic transducer 322) receives reflections of acoustic waves produced by the acoustic transducer excited at frequency 830 depends on the resonant frequency of the receive acoustic transducer shown and described next with respect to graphical representation 802.

Referring next to waveform 822 of graphical representation 802, waveform 822 represents a resonance transfer function of the receive acoustic transducer with respect to voltage 810 and frequency 811. In other words, waveform 822 shows a 3 dB frequency band of the receive acoustic transducer and a resonant frequency at which the receive acoustic transducer is excitable at maximum efficiency. In graphical representation 802, the resonant frequency of the receive acoustic transducer includes frequency 831, while the frequency band of the receive acoustic transducer includes frequency 830 and frequency 831, among other frequencies, partially overlapping the frequency band of the transmit acoustic transducer. Frequency 831 is a resonant frequency of the receive acoustic transducer and is different from frequency 830. The difference can be a mismatch within a relatively small range (e.g., 3%). The mismatch can be due to, for example, temperature, stress, process variation, aging, etc.

Continuing to follow the operational example above, when the transmit acoustic transducer produces the acoustic waves at frequency 830, the acoustic waves reflect off one or more objects and return echoes to the receive acoustic waves also at frequency 830. Because the receive acoustic transducer has a resonant frequency at frequency 831, the receive acoustic transducer might not receive the acoustic waves and produce an electrical signal from the acoustic waves with maximum efficiency as the resonant frequencies of the transmit and receive acoustic transducers are different. Problematically, this may reduce the sensitivity and efficiency of the receive acoustic transducer and degrade a detection process using the electrical signal produced by the receive acoustic transducer, which impacts the performance of the bistatic sensor.

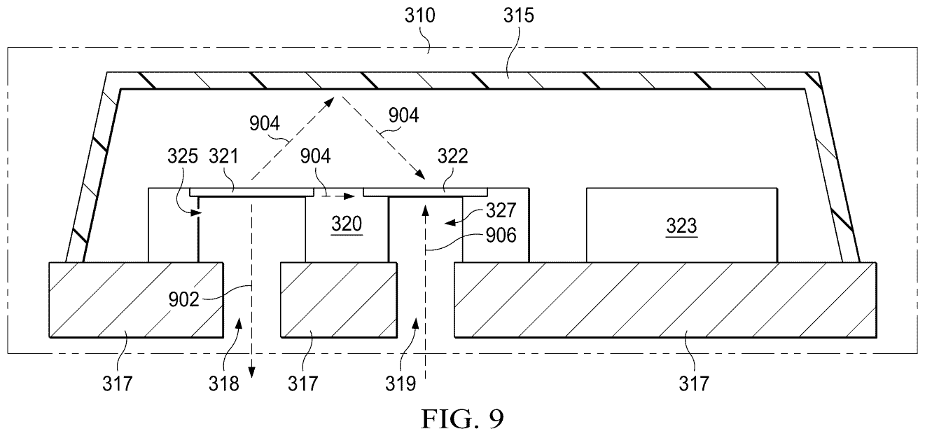

FIG. 9 illustrates sources of cross-talk in bistatic sensor package 310 of FIG. 3. As shown in FIG. 3, as transmit acoustic transducer 321 vibrates and generates acoustic waves 902, which propagates out of bistatic sensor package 310 via a recess 325 and an opening 318, some of the vibration energy 904 can propagate through semiconductor substrate 310 to receive acoustic transducer 322 as cross-talk. As another example, some of the vibration energy 904 can also propagate towards housing 315 and reflected back as echo towards receive acoustic transducer 322. Because transmit acoustic transducer 321 is in close proximity to receive acoustic transducer 322 since both are on the same semiconductor substrate and within an IC package, the vibration energy 904 can be substantial compared with, for example, an echo signal 906 that propagates through opening 319 and recess 327. Accordingly, vibration energy 904 can be converted by receive acoustic transducer 322 into an electric signal, and control circuit 118 may generate detection signal 125 by mistaking vibration energy 904 as an echo signal. The effect of cross-talk can be mitigated by various techniques, such as thresholding and blanking, but each has challenges. Specifically, since vibration energy 904 can be substantial, removing cross-talk by comparing the output of receive acoustic transceiver with a threshold risk removing real echo signals having a low amplitude. Also, blanking receive acoustic transducer 322 within a short window after transmit acoustic transducer 321 transmits acoustic waves may affect detection of close-by objects.

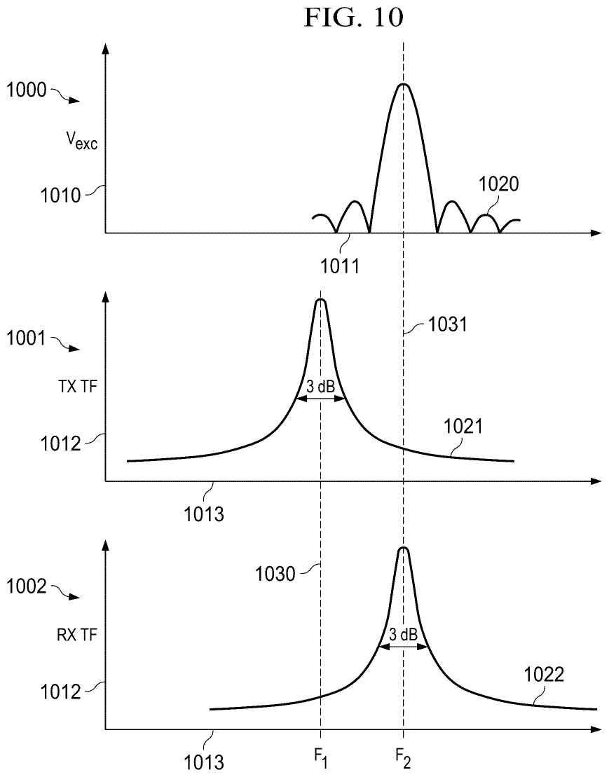

FIG. 10 illustrates operations of a bistatic sensor system including transmit and receive transducers having different resonant frequencies that can address the resonant frequency mismatch issues described in FIG. 8. FIG. 10 shows graphical representations 1000, 1001, and 1002, which show waveforms 1020, 1021, and 1022 respectively, that include values with respect to voltage 1010 and frequency 1011.

Referring first to waveform 1020 of graphical representation 1000, waveform 1020 represents a signal (e.g., signal 210) provided to a transmit acoustic transducer (e.g., transmit acoustic transducer 321) by a driver (e.g., transmit driver 110). More particularly, the signal represents an excitation voltage having a peak amplitude with respect to voltage 1010 at frequency 1031.

In an operational example, when a transmit acoustic transducer receives this signal, the transmit acoustic transducer is excited at frequency 1031, causing the transmit acoustic transducer to produce acoustic waves resonating at frequency 1031. The efficiency and intensity at which the transmit acoustic transducer produces the acoustic waves depends on the resonant frequency of the transmit acoustic transducer shown and described next with respect to graphical representation 1001.

Referring next to waveform 1021 of graphical representation 1001, waveform 1021 represents a resonance transfer function of a transmit acoustic transducer (e.g., transmit acoustic transducer 321) with respect to voltage 1010 and frequency 1011. In other words, waveform 1021 shows a 3 dB frequency band in which the transmit acoustic transducer is operable and a resonant frequency at which the transmit acoustic transducer is excitable at maximum efficiency. In graphical representation 1001, the resonant frequency of the transmit acoustic transducer is at a frequency 1030, while the 3 dB frequency band of transmit acoustic transducer includes frequency 1030 but not frequency 1031.

Following the operational example above, when the transmit acoustic transducer receives the signal represented by waveform 1020, the transmit acoustic transducer might not operate at maximum efficiency as the signal and the resonant frequency of the transmit acoustic transducer are different. While this may reduce efficiency of the transmit acoustic transducer, the amplitude of the excitation provided to the transmit acoustic transducer may be increased beyond a threshold voltage to, for example, saturate the transmit acoustic transducer, so that the amplitude of acoustic waves generated by the transmit acoustic transducer, driven at frequency 1030, can be the same or at least comparable as when the transmit acoustic transducer is driven at its resonant frequency (frequency 1030). The efficiency at which a receive acoustic transducer (e.g., receive acoustic transducer 322) receives reflections of acoustic waves produced by the acoustic transducer excited at frequency 1031 depends on the resonant frequency of the receive acoustic transducer shown and described next with respect to graphical representation 1002.

Referring next to waveform 1022 of graphical representation 1002, waveform 1022 represents a resonance transfer function of the receive acoustic transducer with respect to voltage 1010 and frequency 1011. In other words, waveform 1022 shows a 3 dB frequency band and a resonant frequency at which the receive acoustic transducer is excitable at maximum efficiency. In graphical representation 1002, the resonant frequency of the receive acoustic transducer is at frequency 1031, and the 3 dB frequency band of the receive acoustic transducer, centered around frequency 1031, does not overlap with the 3 dB frequency band of the transmit acoustic transducer.

Continuing to follow the operational example above, when the transmit acoustic transducer produces the acoustic waves at frequency 1031, the acoustic waves reflect off one or more objects and return echoes to the receive acoustic waves also at frequency 1031. Because the receive acoustic transducer has a resonant frequency at frequency 1031, the receive acoustic transducer receives the acoustic waves and produces an electrical signal from the acoustic waves with maximum efficiency as the resonant frequencies of the acoustic waves transmitted by the transmit acoustic transducer and the receive acoustic transducers are the same. Advantageously, excitation and operation of the transmit and receive acoustic transducers may improve performance of a bistatic sensor and associated object detection operation by intentionally exciting the transmit acoustic transducer at the resonant frequency of the receive acoustic transducer. Because the bistatic sensor system is designed and operated to maximize the receive acoustic transducer's sensitivity with the assumption that the transmit and receive acoustic transducers have the different resonant frequency, the resonant frequency mismatch between the transmit and receive acoustic transducers, such as the example shown in FIG. 8, has very little or no effect on the performance of the bistatic sensor system.

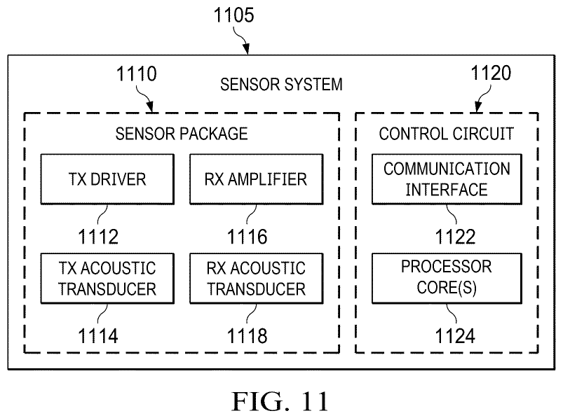

FIG. 11 illustrates an example of a sensor system 1100, which includes a sensor package 1110 and a control circuit 1120. Sensor package 1110 includes a transmit driver 1112, a transmit acoustic transducer 1114, a receive amplifier 1116, and a receive acoustic transducer 1118. Control circuit 1120 includes a communication interface 1122 and a processor core(s) 1124. Control circuit 1120 may be configurable to perform signal transmission, signal reception, digital signal processing, and object detection operations, among other operations, with respect to various other elements of sensor system 1100, such as operations of method 1200 of FIG. 12. Accordingly, control circuit 1120 may include hardware, software, and/or firmware, as well as combinations and variations thereof, for performing the operations described herein, an example of which is shown by computing system 1601 of FIG. 16.

In various examples, sensor system 1100 is representative of a system including various electronic, electrical, and hardware components integrated into a single package covered, at least partially, by a package material (e.g., a metal material, a plastic material). Elements of sensor system 1100 may be configurable to perform ultrasonic sensing operations, digital signal processing operations, object detection operations, and the like, as described herein. To perform such functions, sensor system 1100 includes sensor package 1110 and control circuit 1120.

Sensor package 1110 may be representative of a bistatic sensor package (e.g., bistatic sensor package 220) configurable to transmit and receive acoustic waves for object detection purposes, among other functions. Sensor package 1110 includes transmit driver 1112, transmit acoustic transducer 1114, receive amplifier 1116, and receive acoustic transducer 1118.

Transmit acoustic transducer 1114 may be representative of an acoustic transducer configurable to receive electrical signals and produce acoustic waves for transmission into the air. In various examples, transmit acoustic transducer 1114 may operate within a first frequency band (e.g., a 3 dB frequency range) and has a first resonant frequency within the first frequency band. The first resonant frequency refers to a frequency at which transmit acoustic transducer 1114 vibrates and generates the acoustic waves with maximum amplitude when excited by the electrical signals. The resonant frequency may be determined based on various properties of transmit acoustic transducer 1114, such as material characteristics, dimensions, and structural characteristics. In other words, transmit acoustic transducer 1114 operates most efficiently when excited at its resonant frequency, thus converting electrical energy into acoustic energy with minimal energy loss relative to excitation at other frequencies.

Receive acoustic transducer 1118 may be representative of an acoustic transducer configurable to receive incoming acoustic waves (e.g., sound pressure variations) and convert the acoustic waves into electrical signals. When the acoustic waves reach receive acoustic transducer 1118, the acoustic waves induce mechanical vibrations in a material of receive acoustic transducer 1118, which generates an electrical signal (e.g., through a piezoelectric effect) having a voltage proportional to the intensity of the acoustic pressure. In various examples, receive acoustic transducer 1118 operates within a second frequency band (e.g., a 3 dB range) different from and not overlapping the first frequency band of transmit acoustic transducer 112 and has a second resonant frequency within the second frequency band, unlike the operation described above with respect to circuit 900. In this way, the difference between the operating and/or resonant frequencies of receive acoustic transducer 1118 and transmit acoustic transducer 1114 is several orders of magnitudes higher than a difference caused by a random mismatch between transducers configurable to have the same resonant frequency, which may reduce cross-talk within sensor package 1110. The second resonant frequency refers to a frequency at which receive acoustic transducer 1118 vibrates and converts acoustic waves into electrical signals with maximum efficiency (i.e., least amount of loss). The resonant frequency of receive acoustic transducer 1118 may be determined based on various properties of receive acoustic transducer 1118, such as material characteristics, dimensions, and structural characteristics.

The combination of transmit acoustic transducer 1114 and receive acoustic transducer 1118 forms a bistatic sensor within sensor package 1110 configurable to perform signal transmission and signal reception, respectively, for various applications, such as object detection. In some examples, transmit acoustic transducer 1114 and receive acoustic transducer 1118 include capacitive micromachined ultrasonic transducers (CMUTs), piezoelectric micromachined ultrasonic transducers (PMUTs), FeCaps, etc. Other types of transducers, as well as combinations and variations thereof, may be contemplated.

The bistatic sensor formed by transmit acoustic transducer 1114 and receive acoustic transducer 1118 may be operable to perform respective functions via transmit driver 1112 and receive amplifier 1116. In various examples, transmit driver 1112 is representative of circuitry configurable to provide electrical signals to transmit acoustic transducer 1114 to control operations thereof. More particularly, transmit driver 1112 generates an electrical signal having a voltage and a frequency, with which transmit acoustic transducer 1114 generates and emits acoustic waves. The acoustic waves emitted by transmit acoustic transducer 1114 may reflect off an object, creating echoes, or reflected acoustic waves. The reflected acoustic waves are received and converted into electrical signals by receive acoustic transducer 1118. Receive amplifier 1116, representative of circuitry configurable to amplify the electrical signals output by receive acoustic transducer 1118 (e.g., an analog front end (AFE)), processes the electrical signals and provides the processed electrical signals downstream to control circuit 1120. By way of example, receive amplifier 1116 may include one or more filters, amplifiers, gain compensation circuits, and the like, to filter, convert, and/or amplify values of the electrical signals.

Control circuit 1120 may be representative of a control system including various hardware, firmware, and software elements, such as communication interface 1122 and processor core(s) 1124, among other elements. Communication interface 1122 is representative of an input/output interface with which control circuit 1120 communicates with sensor package 1110 and external devices and/or systems. Processor core(s) 1124 is representative of one or more processing devices, processing systems, or the like configurable to perform functions like object detection based on the processed electrical signals provided to control circuit 1120 via communication interface 1122 by receive amplifier 1116. Additionally, or alternatively, processor core(s) 1124 of control circuit 1120 may be configurable to control operations of transmit driver 1112 and receive amplifier 1116, and thus, transmit acoustic transducer 1114 and receive acoustic transducer 1118, respectively. For example, processor core(s) 1124 may direct transmit driver 1112 to provide an electrical signal to transmit acoustic transducer 1114 having a target voltage and/or frequency.

Examples of the one or more processor core(s) 1124 include one or more central processing units (CPUs), graphical processing units (GPUs), general purpose processors, microcontroller units, microprocessors, digital signal processors (DSPs), field-programmable gate arrays (FPGAs), application-specific integrated circuits (ASICs), and the like, as well as combinations and variations thereof. As such, processor core(s) 1124 may include hardware, software, and/or firmware with which to further process the processed electrical signals to determine information about an object within proximity of sensor system 1100, for example.

FIG. 12 illustrates method 1200 for operating a bistatic sensor in an implementation. In various examples, method 1200 may be implemented in hardware, software, and/or firmware, as well as combinations and variations thereof. For example, method 1200 may be implemented in control circuit 118 of FIGS. 1A and 1B and in control circuit 1120 of FIG. 11. While method 1200 may be performed by various elements described herein, the following discussion includes and references elements of FIG. 11 for the sake of simplicity.

To begin, in operation 1205, a control circuit (e.g., processor core(s) 1124 of control circuit 1120, control circuit 118, etc.) directs a transmit driver (e.g., transmit driver 1112, transmit driver 110, etc.) to transmit a signal at a frequency to a transmit acoustic transducer (e.g., 1114, or other examples described herein) causing transmit acoustic transducer 1114 to produce acoustic waves at the frequency. In various examples, the transmit acoustic transducer 1114 has a different resonant frequency than the frequency of the signal driven to transmit acoustic transducer 1114 by transmit driver 1112. Accordingly, transmit acoustic transducer 1114 is operated “off-resonance.”

Next, in operation 1210, the control circuit receives a signal from a receive acoustic transducer (e.g., 1118, or other examples described herein) via a receive amplifier (e.g., 1116, or other examples described herein) at the frequency. More specifically, upon transmission of the acoustic waves by transmit acoustic transducer 1114, the acoustic waves propagate through air, reflect off one or more objects, and return towards sensor system 1100. Receive acoustic transducer 1118 receives the returned acoustic waves and generates the signal based on the received acoustic waves. In various examples, receive acoustic transducer 1118 has a resonant frequency that is the same as the frequency at which transmit acoustic transducer 1114 is excited. Receive acoustic transducer 1118 provides the generated signal to receive amplifier 1116, which processes the signal and provides the signal to processor core(s) 1124 via communication interface 1122.

In operation 1215, the control circuit generates a signal representing detection of the one or more objects based on the signal provided to processor core(s) 1124 by receive amplifier 1116. The signal generated by processor core(s) may be used to identify information about the object(s) at which the transmitted acoustic waves were directed. For example, the signal may include a distance between sensor system 1100 and the object(s), a predicted shape or size of the object(s), and the like. In some examples, processor core(s) 1124 may provide the detection signal downstream to one or more devices external to sensor system 1100 via communication interface 1122.

FIG. 13 illustrates an example of a packaged integrated circuit 1305, which includes a transmit driver 1310, a transmit acoustic transducer 1312, a receive amplifier 1314, a receive acoustic transducer 1316, a control circuit 1318, and a calibration circuit 1320. As to be described herein, calibration circuit 1320 can perform a calibration operation to determine the resonant frequency of the receive acoustic transducer 1316 as well as cross-talk between transmit acoustic transducer 1312 and receive acoustic transducer 1316. Determining the resonant frequency of the receive acoustic transducer 1316 allows transmit driver 1310 to drive transmit acoustic transducer 1312 at the precise resonant frequency of receive acoustic transducer 1316, which can improve the sensitivity of receive acoustic transducer 1316 in detecting echo signals. Also, determining the cross-talk allows control circuit 1318 to post-process the signal output by receive acoustic transducer 1316 to eliminate or at least reduce cross-talk components in the signal. All these can improve the robustness of bistatic sensor and allow the bistatic sensor to be integrated in a same IC package.

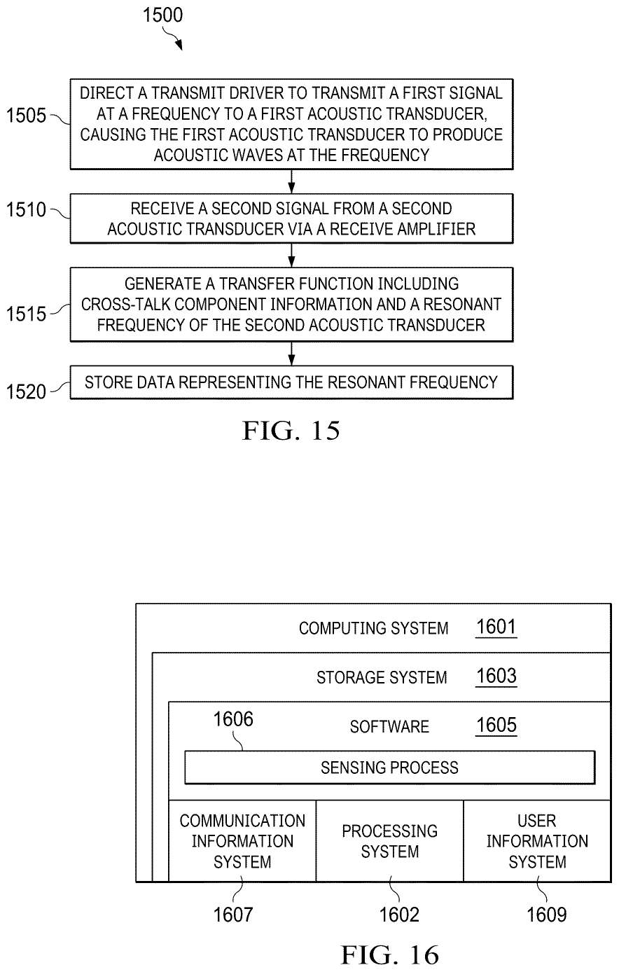

Specifically, control circuit 1318 may be configurable to perform signal transmission, signal reception, digital signal processing, and object detection operations, among other operations, with respect to various other elements of packaged integrated circuit 1305, such as operations of method 1200 of FIG. 12. Calibration circuit 1320 may be configurable to perform calibration operations, among other operations, with respect to various other elements of packaged integrated circuit 1305, such as operations of method 1500 of FIG. 15. Accordingly, control circuit 1318 and calibration circuit 1320 may each include hardware, software, and/or firmware, as well as combinations and variations thereof, for performing the operations described herein, an example of which is shown by computing system 1601 of FIG. 16.

In various examples, packaged integrated circuit 1305 is representative of a circuit including various electronic, electrical, and hardware components integrated into a single package covered, at least partially, by a package material (e.g., a metal material, a plastic material). Elements of packaged integrated circuit 1305 may be configurable to perform ultrasonic sensing operations, digital signal processing operations, object detection operations, calibration operations, and the like, as described herein. To perform such functions, packaged integrated circuit 1305 includes transmit driver 1310, transmit acoustic transducer 1312, receive amplifier 1314, receive acoustic transducer 1316, control circuit 1318, and calibration circuit 1320.

Transmit acoustic transducer 1312 may be representative of an acoustic transducer configurable to receive electrical signals and produce acoustic waves for transmission into the air. In various examples, transmit acoustic transducer 1312 operates within a first frequency band (e.g., a 3 dB range) and has a first resonant frequency within the first frequency band. The first resonant frequency refers to a frequency at which transmit acoustic transducer 1312 vibrates and generates the acoustic waves with maximum amplitude when excited by the electrical signals. The resonant frequency may be determined based on various properties of transmit acoustic transducer 1312, such as material characteristics, dimensions, and structural characteristics. In other words, transmit acoustic transducer 1312 operates most efficiently when excited at its resonant frequency, thus converting electrical energy into acoustic energy with minimal energy loss relative to excitation at other frequencies.

Receive acoustic transducer 1316 may be representative of an acoustic transducer configurable to receive incoming acoustic waves (e.g., sound pressure variations) and convert the acoustic waves into electrical signals. When the acoustic waves reach receive acoustic transducer 1316, the acoustic waves induce mechanical vibrations in a material of receive acoustic transducer 1316, which generates an electrical signal (e.g., through a piezoelectric effect) having a voltage proportional to the intensity of the acoustic pressure. In various examples, receive acoustic transducer 1316 operates within a second frequency band (e.g., a 3 dB range) different from and not overlapping the first frequency band of transmit acoustic transducer 1312 and has a second resonant frequency within the second frequency band. In this way, the difference between the operating and/or resonant frequencies of receive acoustic transducer 1316 and transmit acoustic transducer 1312 is several orders of magnitudes higher than a difference caused by a random mismatch between transducers configurable to have the same resonant frequency. The second resonant frequency refers to a frequency at which receive acoustic transducer 1316 vibrates and converts acoustic waves into electrical signals with maximum efficiency (i.e., least amount of loss). The resonant frequency of receive acoustic transducer 1316 may be determined based on various properties of receive acoustic transducer 1316, such as material characteristics, dimensions, and structural characteristics.

The combination of transmit acoustic transducer 1312 and receive acoustic transducer 1316 forms a bistatic sensor within packaged integrated circuit 1305 configurable to perform signal transmission and signal reception, respectively, for various applications, such as object detection. In some examples, transmit acoustic transducer 1312 and receive acoustic transducer 1316 include CMUTs, PMUTs, FeCaps, etc. Other types of transducers, as well as combinations and variations thereof, may be contemplated.

The bistatic sensor formed by transmit acoustic transducer 1312 and receive acoustic transducer 1316 may be operable to perform respective functions via transmit driver 1310 and receive amplifier 1314. In various examples, transmit driver 1310 is representative of circuitry configurable to provide electrical signals to transmit acoustic transducer 1312 to control operations thereof. More particularly, transmit driver 1310 generates an electrical signal having a voltage and a frequency, with which transmit acoustic transducer 1312 generates and emits acoustic waves. The acoustic waves emitted by transmit acoustic transducer 1312 may reflect off an object, creating echoes, or reflected acoustic waves. The reflected acoustic waves are received and converted into electrical signals by receive acoustic transducer 1316. Receive amplifier 1314, representative of circuitry configurable to amplify the electrical signals output by receive acoustic transducer 1316 (e.g., an analog front end (AFE)), processes the electrical signals and provides the processed electrical signals downstream to control circuit 1318. By way of example, receive amplifier 1314 may include one or more filters, amplifiers, gain compensation circuits, and the like, to filter, convert, and/or amplify values of the electrical signals.

Control circuit 1318 may be representative of one or more processor cores, processing devices, processing systems, or the like configurable to perform functions like object detection based on the processed electrical signals provided to control circuit 1318 by receive amplifier 1314. Additionally, or alternatively, control circuit 1318 may be configurable to control operations of transmit driver 1310 and receive amplifier 1314, and thus, transmit acoustic transducer 1312 and receive acoustic transducer 1316, respectively. For example, control circuit 1318 may direct transmit driver 1310 to provide an electrical signal to transmit acoustic transducer 1312 having a target voltage and/or frequency.

In various examples, calibration circuit 1320 is implemented in one or more processor cores, processing devices, processing systems, or the like configurable to perform calibration operations involving transmit acoustic transducer 1312 and receive acoustic transducer 1316. More particularly, in a calibration operation, calibration circuit 1320 may produce and provide calibration signals to transmit acoustic transducer 1312, then analyze signals generated by receive acoustic transducer 1316 in response to transmit acoustic transducer 1312 transmitting acoustic waves to determine a current resonant frequency of receive acoustic transducer 1316, as well as a transfer function including components caused by cross-talk. The calibration signals may include one or more pulses and may include a fewer number of pulses (or span a shorter duration) than in a case where the signals are transmitted for an object detection and ranging operation such as shown in FIG. 1B. Also, to determine cross-talk, the calibration operation can be performed in an environment where no object is nearby, and only signals received by receive acoustic transducer 1316 immediately after transmission by transmit acoustic transducer 1312 (e.g., based on propagation time of the cross-talk) are processed to extract the cross-talk component. Calibration circuit 1320 can perform a transform operation (e.g., Fourier transform operation) on the signals produced by receive acoustic transducer 1316 (as output) and the signals produced by transmit acoustic transducer 1312 (as input) to determine a frequency domain representation of a transfer function. The frequency at the peak value of the transfer function can be identified as the resonant frequency of receive acoustic transducer 1316, whereas subsequent signals produced by receive acoustic transducer 1316 can be processed with the transfer function to determine the cross-talk components of the signals, which can then be subtracted from the subsequent signals produced by receive acoustic transducer 1316 to eliminate/reduce the effect of cross-talk.

In this way, calibration circuit 1320 may determine the resonant frequency of receive acoustic transducer 1316 at a given time despite changes in the original resonant frequency of receive acoustic transducer 1316 caused by one or more factors like age, stress, and the like. Calibration circuit 1320 can also allow elimination/attenuation of cross-talk components in the signals output by receive acoustic transducer 1316 in subsequent object detection/ranging operations.

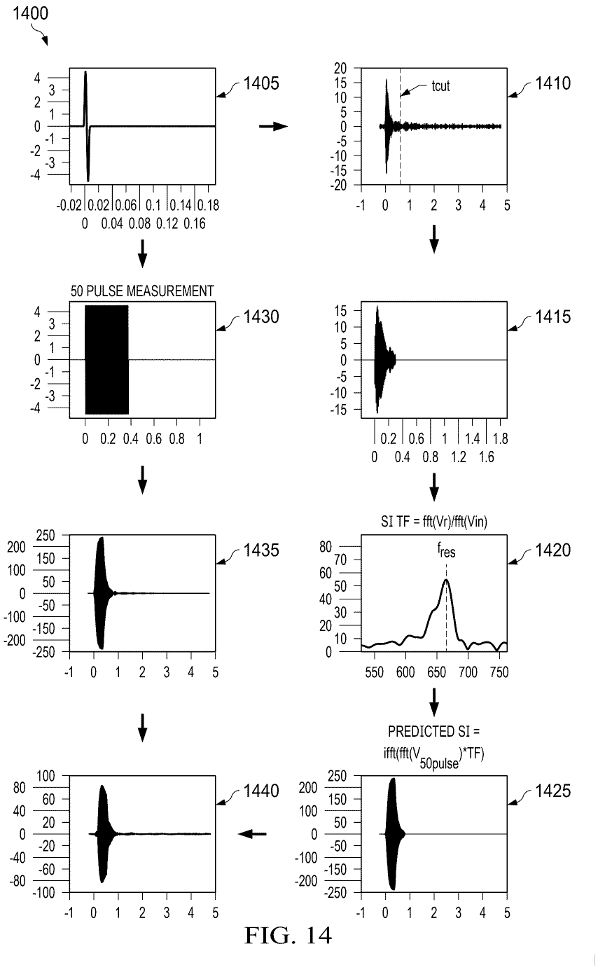

Upon determining a current resonant frequency, calibration circuit 1320 may provide an indication thereof to control circuit 1318 for use in an object detection operation. Additional information about the calibration process is shown and described below with respect to FIGS. 14 and 15.

Examples of the one or more processor cores of control circuit 1318 and/or calibration circuit 1320 include one or more central processing units (CPUs), graphical processing units (GPUs), general purpose processors, microcontroller units, microprocessors, digital signal processors (DSPs), field-programmable gate arrays (FPGAs), application-specific integrated circuits (ASICs), and the like, as well as combinations and variations thereof. As such, control circuit 1318 and calibration circuit 1320 may include hardware, software, and/or firmware with which to further process the processed electrical signals to determine information about an object within proximity of packaged integrated circuit 1305, for example.

FIG. 14 illustrates example aspects of a calibration of a bistatic sensor in an implementation. In particular, FIG. 14 shows a sequence of graphical representations indicative of signals provided to a transmit acoustic transducer (e.g., transmit acoustic transducer 1312) or generated by a receive acoustic transducer (e.g., receive acoustic transducer 1314), illustrative of performance of a calibration operation by a calibration circuit of a system or device, such as calibration circuit 1320 of packaged integrated circuit 1305. Accordingly, the following discussion includes and references elements of FIG. 13.

To begin a calibration process, calibration circuit 1320 directs transmit driver 1310 to transmit a calibration pulse to transmit acoustic transducer 1312. An example calibration pulse is illustrated in graphical representation 1405. The calibration pulse may include a single at a target frequency. In response to receiving the calibration pulse, transmit acoustic transducer 1312 produces one or more acoustic waves that propagate toward an object near packaged integrated circuit 1305.

Receive acoustic transducer 1314 receives an echo of the acoustic wave(s) at the target frequency and generates a signal based on the echo. An example of the generated signal is shown in graphical representation 1410. Receive amplifier 1316 receives the signal from receive acoustic transducer 1314, processes (e.g., amplifies, filters) the signal, and provides the processed signal to calibration circuit 1320 (either directly or via control circuit 1318).

Calibration circuit 1320 truncates values of the processed signal beyond a threshold time. An example of the truncated signal is shown in graphical representation 1415. The values truncated may be representative of cross-talk between transmit acoustic transducer 1312 and receive acoustic transducer 1314. Calibration circuit 1320 determines the threshold time based on, for example, a propagation time of cross-talk between transmit acoustic transducer 1312 and receive acoustic transducer 1314 so that the truncated signal does not include echo signal reflected off an object.

Calibration circuit 1320 determines a transfer function associated with receive acoustic transducer 1314 based on the truncated signal. An example of the transfer function is shown in graphical representation 1420. The transfer function may be representative of cross-talk component at the output of receive acoustic transducer 1314 with respect to the input to transmit acoustic transducer 1312. As explained above, calibration circuit 1320 can perform transform operation (e.g., Fourier transform operation) on the signals produced by receive acoustic transducer 1316 (as output) and the signals produced by transmit acoustic transducer 1312 (as input) to determine a frequency domain representation of a transfer function. The frequency at the peak of the transfer function, represented as fᵣₑₛ, can be identified as the resonant frequency of receive acoustic transducer 1316. Also, the transfer function, represented by graphical representation 1420, also includes the frequency components of the cross-talk attributed to the calibration pulse(s).

In a subsequent object detection/measurement operation, control circuit 1318 directs transmit driver 1310 to transmit measurement pulses to transmit acoustic transducer 1312. The measurement pulses can include a larger number of pulses (e.g., 50, in the example of FIG. 14) than the calibration pulse (e.g., one, in the example of FIG. 14). The number of pulses of the number of pulses may be based on a quality factor (Q) of receive acoustic transducer 1314. Larger number of measurement pulses can be provided to improve the quality of the echo signals reflected off an object to be detected, especially if the object is far away. Also, the pulses are transmitted at the resonant frequency of receive acoustic transducer 1316, fᵣₑₛ, determined from the transfer function illustrated in graphical representation 1420 as described above. Transmit acoustic transducer 1312, driven by the measurement pulses, generate acoustic waves that propagate out of packaged integrated circuit 1305.

Receive acoustic transducer 1314 receives echo signals of the acoustic waves and convert the echo signals, which can also include cross-talk components, into electrical signals, which are then amplified by receive amplifier 1316. An example of the electrical signals output by receive amplifier 1316 is shown in graphical representation 1435. Th electrical signals are then provided to control circuit 1318.

Next, control circuit 1318 extract the cross-talk components from the electrical signals produced by receive amplifier 1316 using the transfer function based on the following Equation:

cross−talk=IFFT(FFT(V50pulses)*TF) (Equation 1)

In Equation 1, V50pulses represent the measurement pulses provided as input to transmit acoustic transducer 1312. TF represents the transfer function. FFT refers to fast fourier transform, and IFFT refers inverse FFT. Control circuit 1318 can perform FFT (or other transform operations) on the measurement pulses to generate a frequency domain representation, and multiply the frequency domain represent of the measurement pulses with the transfer function to obtain a frequency domain representation of the cross-talk caused by the measurement pulses. Control circuit 1318 can then perform IFFT to convert the cross-talk from frequency domain representation back to time domain representation. The time domain representation of cross-talk, caused by the measurement pulses, is represented by graphical representation 1425. Control circuit 1318 can then subtract the cross-talk component from the from the electrical signals produced by receive amplifier 1316, represented by graphical representation 1435, to obtain a post-processed version of the electrical signals with cross-talk components substantially eliminated/attenuated, as represented by graphical representation 1440.

FIG. 15 illustrates method 1500 for performing a calibration operation of a bistatic sensor in an implementation. In various examples, method 1500 may be implemented in hardware, software, and/or firmware, as well as combinations and variations thereof. For example, method 1500 may be implemented in calibration circuit 1320 of FIG. 13. Method 1500 are described below with respect to elements of FIG. 13.

To begin, in operation 1505, calibration circuit 1320 directs transmit driver 1310 to transmit a first signal at a frequency to transmit acoustic transducer 1312 causing transmit acoustic transducer 1312 to produce acoustic waves at the frequency. The first signal can include a single or multiple pulses and can include a fewer number of pulses than the measurement pulses transmitted during an object detection/ranging operation.

In operation 1510, calibration circuit 1320 receives a second signal from receive acoustic transducer 1316 via receive amplifier 1314. The second signal can include cross-talk components. The second signal can be received almost immediately after transmit acoustic transducer 1312 transmits the first signal (e.g., within a timing window as shown in FIG. 13) so that the second signal does not contain echo signal reflected from an object and only include cross-talk components that propagate within the packaged IC.

In operation 1515, calibration circuit 1320 can generate a transfer function that includes cross-talk component information and resonant frequency of receive acoustic transducer 1316. To generate the transfer function, calibration circuit 1320 can perform a transform operation (e.g., Fourier transform operation) on the signals produced by receive acoustic transducer 1316 (as output) and the signals produced by transmit acoustic transducer 1312 (as input) to determine a frequency domain representation of a transfer function. The frequency at the peak of the transfer function, represented as fᵣₑₛ, can be identified as the resonant frequency of receive acoustic transducer 1316. Also, the transfer function, represented by graphical representation 1420, represents the frequency components of the cross-talk attributed to the calibration pulse(s).

In operation 1520, calibration circuit 1320 stores data representing the resonant frequency of receive acoustic transducer 1314 as well as the transfer function. Calibration circuit 1320 may provide this data to control circuit 1318 prior to a subsequent object detection process. For example, control circuit 1318 can drive transmit acoustic transducer 1312 at the resonant frequency determined in operation 1515, and post-process the signals produced by receive acoustic transducer 1314 using the transfer function based on Equation 1, as explained above.

In various examples, calibration circuit 1320 is configurable to perform method 1500 periodically, before every object detection process, or randomly throughout the life and operation of packaged integrated circuit 1305. In this way, calibration circuit 1320 can advantageously ensure that control circuit 1318 excites transmit acoustic transducer 1312 at the current resonant frequency of receive acoustic transducer 1314 at a given time in accordance with the techniques and benefits described herein.

FIG. 16 illustrates computing system 1601 to perform signal transmission, signal reception, object detection, and sensor calibration according to an implementation of the present technology. Computing system 1601 is representative of any system or collection of systems with which the various operational architectures, processes, scenarios, and sequences disclosed herein for memory access control may be employed. Computing system 1601 may be implemented as a single apparatus, system, or device or may be implemented in a distributed manner as multiple apparatuses, systems, or devices. Computing system 1601 includes, but is not limited to, processing system 1602, storage system 1603, software 1605, communication interface system 1607, and user interface system 1609 (optional). Processing system 1602 is operatively coupled with storage system 1603, communication interface system 1607, and user interface system 1609. Computing system 1601 may be representative of a cloud computing device, distributed computing device, or the like.

Processing system 1602 loads and executes software 1605 from storage system 1603. Software 1605 includes and implements sensing process 1606, which is representative of any of the signal transmission, signal reception, sensor calibration, and object detection processes discussed with respect to the preceding Figures. When executed by processing system 1602 to provide sensor and object detection functions, software 1605 directs processing system 1602 to operate as described herein for at least the various processes, operational scenarios, and sequences discussed in the foregoing implementations. Computing system 1601 may optionally include additional devices, features, or functionality not discussed for purposes of brevity.

Referring still to FIG. 16, processing system 1602 may comprise a micro-processor and other circuitry that retrieves and executes software 1605 from storage system 1603. Processing system 1602 may be implemented within a single processing device but may also be distributed across multiple processing devices or sub-systems that cooperate in executing program instructions. Examples of processing system 1602 include general purpose central processing units, graphical processing units, application specific processors, and logic devices, as well as any other type of processing device, combinations, or variations thereof.

Storage system 1603 may comprise any computer readable storage media readable by processing system 1602 and capable of storing software 1605. Storage system 1603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1603 may also include computer readable communication media over which at least some of software 1605 may be communicated internally or externally. Storage system 1603 may be implemented as a single storage device but may also be implemented across multiple storage devices or sub-systems co-located or distributed relative to each other. Storage system 1603 may comprise additional elements, such as a controller, capable of communicating with processing system 1602 or possibly other systems.

Software 1605 (including sensor process 1606) may be implemented in program instructions and among other functions may, when executed by processing system 1602, direct processing system 1602 to operate as described with respect to the various operational scenarios, sequences, and processes illustrated herein. For example, software 1605 may include program instructions for implementing an object detection and sensor operation and calibration processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1605 may include additional processes, programs, or components, such as operating system software, virtualization software, or other application software. Software 1605 may also comprise firmware or some other form of machine-readable processing instructions executable by processing system 1602.

In general, software 1605 may, when loaded into processing system 1602 and executed, transform a suitable apparatus, system, or device (of which computing system 1601 is representative) overall from a general-purpose computing system into a special-purpose computing system customized to provide memory access as described herein. Indeed, encoding software 1605 on storage system 1603 may transform the physical structure of storage system 1603. The specific transformation of the physical structure may depend on various factors in different implementations of this description. Examples of such factors may include, but are not limited to, the technology used to implement the storage media of storage system 1603 and whether the computer-storage media are characterized as primary or secondary storage, as well as other factors.

For example, if the computer readable storage media are implemented as semiconductor-based memory, software 1605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1607 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

The following figures and corresponding discussion relate to examples including a bistatic sensor and an acoustic waveguide configurable to shape the field of view and improve directivity of the bistatic sensor in various applications. In some examples, the acoustic waveguide discussed below may be implemented with a bistatic sensor having transducers with intentionally, and substantially different resonant frequencies, such as various examples described above with respect to FIGS. 1A through 16. In some examples, the acoustic waveguide discussed below may be implemented with a bistatic sensor having transducers with the same, or similar, resonant frequencies. Regardless of the resonant frequency of the transducers and operation thereof, the acoustic waveguides discussed herein may provide technical advantages of eliminating or reducing blind spots with respect to transmission and reception of acoustic waves, improving pulse-echo directivity with respect to transmission and reception of acoustic waves, and enhancing beam-shaping flexibility in bistatic sensor applications.

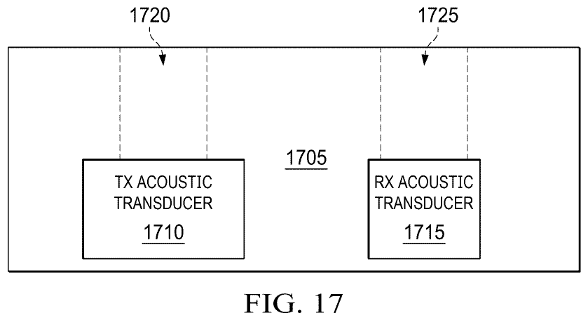

Moving to FIG. 17, FIG. 17 illustrates an example aspect of a packaged integrated circuit (e.g., packaged integrated circuit 100) in an implementation. More particularly, FIG. 17 shows a packaged integrated circuit 1705, which includes a transmit acoustic transducer 1710 and a receive acoustic transducer 1715.

In various examples, packaged integrated circuit 1705 is representative of a device including various electronic, electrical, and hardware components integrated into a single package covered, at least partially, by a package material (e.g., a metal material, a plastic material). Elements of packaged integrated circuit 1705, such as transmit acoustic transducer 1710 and receive acoustic transducer 1715, may be configurable to perform ultrasonic wave generation, transmission, and reception used in ultrasonic sensing operations, digital signal processing operations, object detection operations, and the like, as described herein. While only transmit acoustic transducer 1710 and receive acoustic transducer 1715 are shown, several other components may be included to control the transducers and process signals to/from the transducers, such as one or more drivers (e.g., transmit driver 110), amplifiers (e.g., receive amplifier 114), control circuitry (e.g., control circuit 118), and the like.

Transmit acoustic transducer 1710 may be representative of an acoustic transducer configurable to receive electrical signals and produce acoustic waves for transmission into the air. In various examples, transmit acoustic transducer 1710 operates within a first frequency band and has a first resonant frequency within the first frequency band. The first resonant frequency may be a frequency at which transmit acoustic transducer 1710 vibrates and generates the acoustic waves with maximum amplitude when excited by the electrical signals.

Receive acoustic transducer 1715 may be representative of an acoustic transducer configurable to receive incoming acoustic waves (e.g., sound pressure variations) and convert the acoustic waves into electrical signals. When the acoustic waves reach receive acoustic transducer 1715, the acoustic waves induce mechanical vibrations in a material of receive acoustic transducer 1715, which generates an electrical signal (e.g., through a piezoelectric effect) having a voltage proportional to the intensity of the acoustic pressure. In various examples, receive acoustic transducer 116 operates within a second frequency band and has a second resonant frequency, both of which may be the same, similar, or different from those of transmit acoustic transducer 1710.

The combination of transmit acoustic transducer 1710 and receive acoustic transducer 1715 forms a bistatic sensor within packaged integrated circuit 1705 configurable to perform signal transmission and signal reception, respectively, for various applications, such as object detection. In some examples, transmit acoustic transducer 1710 and receive acoustic transducer 1715 include capacitive micromachined ultrasonic transducers (CMUTs). In some examples, transmit acoustic transducer 112 and receive acoustic transducer 116 include piezoelectric micromachined ultrasonic transducers (PMUTs). Other types of transducers, as well as combinations and variations thereof, may be contemplated.

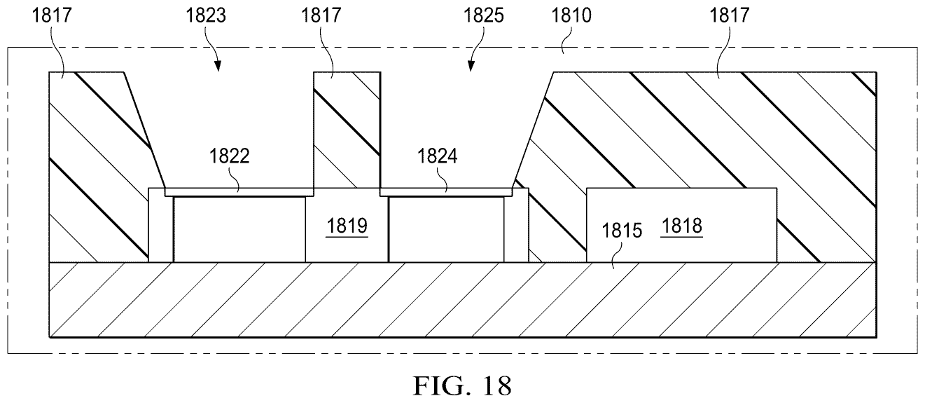

The bistatic sensor formed by transmit acoustic transducer 1710 and receive acoustic transducer 1715 is included in package material, such as a housing (e.g., housing 315, molding compound 417), a package substrate (e.g., package substrate 317), and a semiconductor substrate (e.g., semiconductor substrate 320), which may protect and insulate parts of the bistatic sensor, among other circuitry. Such elements are shown and described in further detail in FIGS. 18, 19, and 20 below.

As shown in FIG. 17, packaged integrated circuit 1705 includes openings 1720 and 1725 that penetrate the package material, creating a window through which transmit acoustic transducer 1710 and receive acoustic transducer 1715 can transmit and receive acoustic waves, respectively. More particularly, opening 1720 includes a first opening proximal to transmit acoustic transducer 1710 and a second opening distal from transmit acoustic transducer 1710. Similarly, opening 1725 includes a first opening proximal to receive acoustic transducer 1715 and a second opening distal from receive acoustic transducer 1715.

The size and shape of openings 1720 and 1725 may be selected based on a target field of view of transmit acoustic transducer 1710 and receive acoustic transducer 1715, respectively, as well as a target wavelength of acoustic signals transmitted and received by transmit acoustic transducer 1710 and receive acoustic transducer 1715, respectively, among other operational parameters. In various examples, the size of the proximal openings of openings 1720 and 1725 are selected such that the length or width of transmit acoustic transducer 1710 and receive acoustic transducer 1715, respectively, extend across an entire respective proximal opening. Advantageously, this may eliminate or reduce blind spot issues with respect to acoustic wave transmission and reception.

FIG. 18 shows bistatic sensor package 1810, which can be an example of packaged integrated circuit 100 of FIGS. 1A and 1B. As shown in FIG. 18, a bistatic sensor package 1810 includes a molding compound 1817, a package substrate 1815, a semiconductor substrate 1819, an acoustic transducer 1822 and an acoustic transducer 1824 formed on semiconductor substrate 1819, and circuitry 1818, which can be similar to, respectively, molding compound 417, package substrate 415, semiconductor substrate 419, acoustic transducer 420, acoustic transducer 421, and circuitry 418 of FIG. 4.

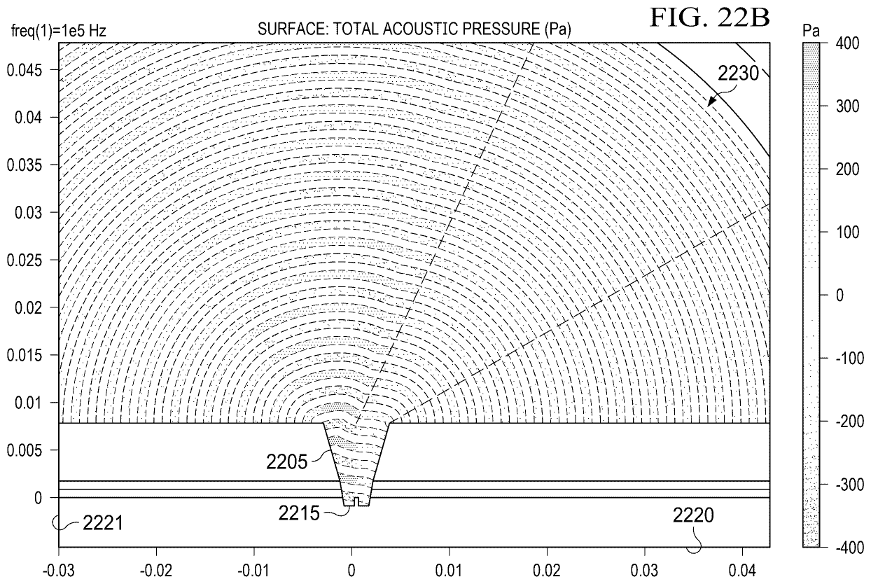

In FIG. 18, molding compound 1817 includes two openings 1823 and 1825 that create separate windows for a transmission path for acoustic transducer 1822 and a reception path for acoustic transducer 1824, respectively. In various examples, acoustic transducers 1822 and 1824 span the length of the bottom of openings 1823 and 1825, respectively, which may reduce or eliminate multiple path diffraction leading to a blind spot, such as a blind spot shown and described below in FIG. 22B.

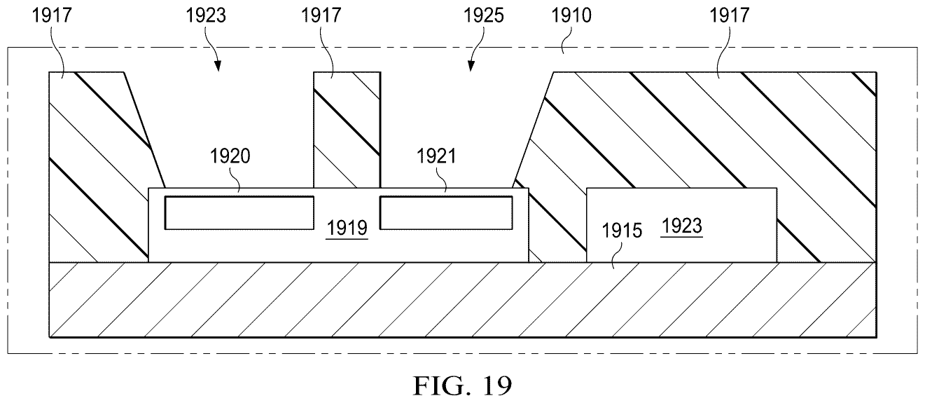

FIG. 19 shows bistatic sensor package 1910, which can be an example of packaged integrated circuit 100 of FIGS. 1A and 1B. As shown in FIG. 19, a bistatic sensor package 1910 includes a molding compound 1917, a package substrate 1915, a semiconductor substrate 1919, an acoustic transducer 1920 and an acoustic transducer 1921 formed on semiconductor substrate 1919, and circuitry 1918, which can be similar to, respectively, molding compound 517, package substrate 515, semiconductor substrate 519, acoustic transducer 520, acoustic transducer 521, and circuitry 518 of FIG. 5.

In FIG. 19, molding compound 1917 includes openings 1923 and 1925 that create separate windows for a transmission path for acoustic transducer 1920 and a reception path for acoustic transducer 1921, respectively. In various examples, acoustic transducers 1920 and 1921 span the length of the bottom of openings 1923 and 1925, respectively, which may reduce or eliminate multiple path diffraction leading to a blind spot, such as blind spot 2230 shown and described below in FIG. 22B.

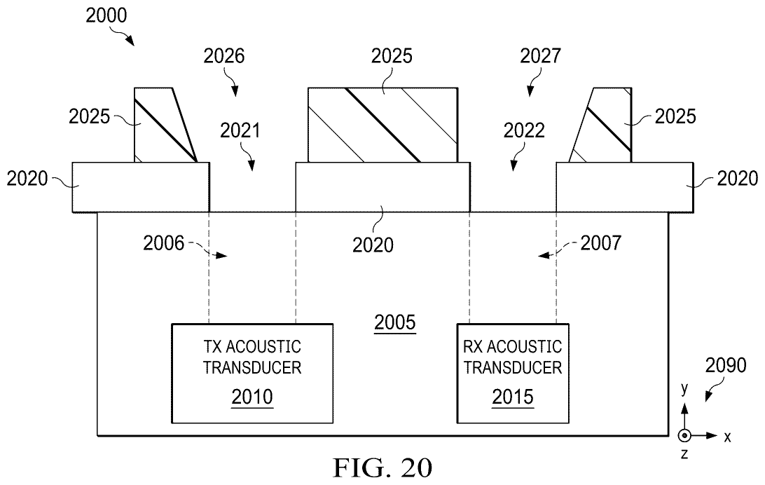

FIG. 20 illustrates a view of apparatus in an implementation with respect to axes 2090. Apparatus 2000 includes a packaged integrated circuit 2005, a circuit board 2020, and an acoustic waveguide 2025.

In various examples, apparatus 2000 is representative of a device including various components configurable to perform ultrasonic wave generation, transmission, and reception used in ultrasonic sensing operations, digital signal processing operations, object detection operations, and the like, as described herein. Additionally, apparatus 2000 may include one or more components configurable to provide beam-shaping capabilities for ultrasonic transmission and reception functionality. In particular, packaged integrated circuit 2005 of apparatus 2000 may provide sensor-based and processing-based functionality, while acoustic waveguide 2025 may provide beam-shaping functionality.

Packaged integrated circuit 2005 is representative of an integrated circuit (IC), such as one described above (e.g., packaged integrated circuit 1705), having a bistatic sensor formed by transmit acoustic transducer 2010 and receive acoustic transducer 2015, sensor control circuitry (e.g., transmit driver 110, receive amplifier 114, circuitry 323), and processing circuitry (e.g., control circuit 118) protected by and encapsulated by package material (e.g., housing 315, package substrate 317).

Transmit acoustic transducer 2010 may be representative of an acoustic transducer configurable to receive electrical signals and produce acoustic waves for transmission into the air, such as one or more of the above transmit acoustic transducers described above (e.g., transmit acoustic transducer 112). Receive acoustic transducer 2015 may be representative of an acoustic transducer configurable to receive incoming acoustic waves (e.g., sound pressure variations) and convert the acoustic waves into electrical signals, such as one or more of the above receive acoustic transducers described above (e.g., receive acoustic transducer 116). The bistatic sensor formed by transmit acoustic transducer 2010 and receive acoustic transducer 2015 is included in package material and may include one or more membranes, electrodes, substrates, and the like.

In various examples, packaged integrated circuit 2005 includes openings 2006 and 2007 that penetrate the package material, creating separate windows through which transmit acoustic transducer 2010 and receive acoustic transducer 2015 can transmit and receive acoustic waves, respectively. Opening 2006 includes a first opening proximal to transmit acoustic transducer 2010 and a second opening distal from transmit acoustic transducer 1710 with respect to the y-axis of axes 790. Similarly, opening 2007 includes a first opening proximal to receive acoustic transducer 2015 and a second opening distal from receive acoustic transducer 2015 with respect to the y-axis of axes 790.

Circuit board 2020 may be representative of a printed circuit board (PCB) coupled to packaged integrated circuit 2005. In some examples, circuit board 2020 includes various nodes, vias, traces, and other electrical elements to which components of packaged integrated circuit 2005 may be coupled. Such elements may provide electrical paths with which components of packaged integrated circuit 2005 communicates to other devices and systems.

Like packaged integrated circuit 2005, circuit board 2020 includes openings 2021 and 2022 that penetrate the material of circuit board 2020 creating separate channels for acoustic wave transmission and reception. In various examples, openings 2021 and 2022 are positioned in-alignment with openings 2006 and 2007, respectively, of packaged integrated circuit 2005 with respect to the x-, y-, and z-axes of axes 2090. In this way, the set of openings 2006 and 2021 provides a window through which transmit acoustic transducer 2010 can transmit acoustic waves, and the set of openings 2007 and 2022 provides a window through which receive acoustic transducer 2015 can receive acoustic waves. In particular, each of openings 2021 and 2022 includes a first opening proximal to a respective transducer and a second opening distal from a respective transducer with respect to the y-axis of axes 2090. The proximal openings of openings 2021 and 2022 may abut the distal openings of openings 2006 and 2007, respectively.

Acoustic waveguide 2025 may be representative of a device configurable to shape outgoing acoustic waves from transmit acoustic transducer 2010 and incoming acoustic waves to receive acoustic transducer 2015 when coupled to circuit board 2020 and packaged integrated circuit 2005. To do so, acoustic waveguide 2025 includes through openings 2026 and 2027, which are representative of separate, distinct openings penetrating acoustic waveguide 2025.

In various examples, through opening 2026 is positioned in-alignment with openings 2021 and 2006 with respect to the x-, y-, and z-axes of axes 2090 such that through opening 2026 overlaps with transmit acoustic transducer 2010 and provides a window through which transmit acoustic transducer 2010 can transmit acoustic waves. Similarly, through opening 2027 is positioned in-alignment with openings 2022 and 2007 with respect to the x-, y-, and z-axes of axes 2090 such that opening 2027 overlaps with receive acoustic transducer 2015 and provides a window through which receive acoustic transducer can receive acoustic waves. In particular, each of through openings 2026 and 2027 includes a first opening proximal to a respective transducer and a second opening distal from a respective transducer with respect to the y-axis of axes 2090. In various examples, through openings 2026 and 2027 taper from the distal openings to the proximal openings. The proximal openings of through openings 2026 and 2027 may abut the distal openings of openings 2021 and 2022, respectively.

In various examples, transmit acoustic transducer 2010 and receive acoustic transducer 2015, openings 2006 and 2007, openings 2021 and 2022, and through openings 2026 and 2027 are positioned symmetrically relative to each other with respect to axes 2090 and with respect to a middle point of packaged integrated circuit 2005. Due to such symmetry, the transducers may have mirrored sensitivity, leading to symmetrical pulse-echo sensitivity in accordance with the Rayleigh theorem of reciprocity.

The size, shape, and positioning of openings 2006, 2007, 2021, and 2022 and through openings 2026 and 2027 may be selected based on a target field of view of the transducers of packaged integrated circuit 2005, as well as a target wavelength of acoustic signals transmitted and received by transmit acoustic transducer 2010 and receive acoustic transducer 2015, respectively, among other operational parameters. In various examples, the lengths or widths of transmit acoustic transducer 2010 and receive acoustic transducer 2015 are selected to extend across the length or width of the distal openings of through openings 2026 and 2027, respectively. Advantageously, this may eliminate or reduce blind spot issues with respect to acoustic wave transmission and reception. Additional information regarding the size, shape, and number of through openings is discussed further below.

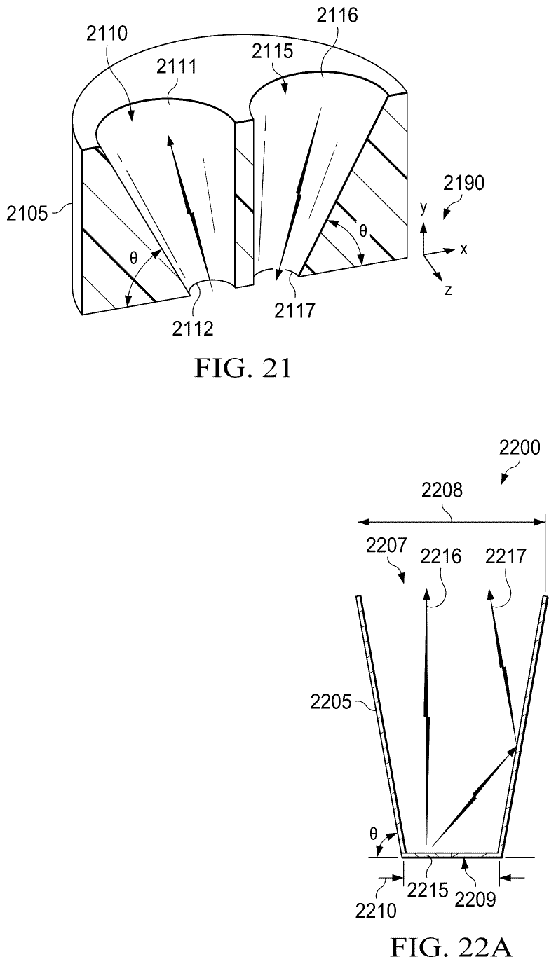

FIG. 21 illustrates a cross-section view of an acoustic waveguide 2100 in an implementation with respect to axes 2190. In various examples, acoustic waveguide 2100 is representative of a device (e.g., acoustic waveguide 2025) configurable to shape acoustic waves to and from a bistatic sensor, such as one or more of the bistatic sensors and accompanying transducers described in detail above.

As shown in FIG. 21, acoustic waveguide 2100 includes through opening 2110 and through opening 2115, which are representative of openings penetrating a body of acoustic waveguide 2100. Through opening 2110 includes a first end at the bottom of acoustic waveguide 2100 (with respect to the y-axis of axes 2190), which is referred to as throat 2112, and a second end at the top of acoustic waveguide 2100 (with respect to the y-axis of axes 2190), which is referred to as mouth 2111. Similarly, through opening 2115 includes a first end at the bottom of acoustic waveguide 2100 (with respect to the y-axis of axes 2190), which is referred to as throat 2117, and a second end at the top of acoustic waveguide 2100 (with respect to the y-axis of axes 2190), which is referred to as mouth 2116.

In various examples, mouths 2111 and 2116, and throats 2112 and 2117 are circularly shaped with mouths 2111 and 2116 being the same size or larger than throats 2112 and 2117, respectively. The dimensions and shapes of through openings 2110 and 2115, as well as the position of through openings 2110 and 2115 relative to one another, may be selected based on a target field of view of transducers of a bistatic sensor (e.g., transmit acoustic transducer 2010, receive acoustic transducer 2015) to which acoustic waveguide 2100 is applied. Furthermore, such properties may be selected based on a target wavelength of acoustic signals transmitted and received by the transducers.

In some examples where mouths 2111 and 2116 have a greater length or width (with respect to the x-axis or z-axis, respectively, of axes 2190) than throats 2112 and 2117, respectively, the length or width of mouths 2111 and 2116 may be selected based on a desired directivity pattern with respect to the propagation of acoustic waves into the air. More particularly, the length or width of mouths 2111 and 2116 might be selected such that the slope angle θ of the internal surfaces of openings 2110 and 2115 with respect to the transducer surface (assumed to be x-axis in FIG. 21), is between a first threshold value (e.g., approximately 45 degrees) and a second threshold value (e.g., approximately 90 degrees). In this way, the path through which acoustic waves travel might not be too wide or too narrow, leading to performance issues of the bistatic sensor, as to be explained below. Other sizes, shapes, gradients, and positioning of elements of acoustic waveguide 2100 may be contemplated.

FIG. 22A illustrates an example aspect of an acoustic waveguide and signals passing through the acoustic waveguide in an implementation. FIG. 22A shows aspect 2200, which includes a view of a through opening 2205 of an acoustic waveguide (e.g., acoustic waveguide 2100) and dimensions thereof.

In various examples, through opening 2205 is representative of one of two or more openings that penetrate an acoustic waveguide, such as through opening 2110, and provide an opening through which acoustic waves propagate to or from a transducer of a bistatic sensor, such as transmit acoustic transducer 2010 or receive acoustic transducer 2015, respectively. In the example shown in aspect 2200, through opening 2205 is applied to transducer 2215. Transducer 2215 is representative of a transmit acoustic transducer (e.g., transmit acoustic transducer 2010) configurable to transmit acoustic waves that travel within through opening 2205 away from transducer 2215 and towards an object external to through opening 2205, such as waves 2216 and 2217.

Through opening 2205 includes a first end proximal to transducer 2215, end 2209, and a second end distal from transducer 2215, end 2207. End 2207 includes a length 2208, and end 2209 includes a length 2210. In some examples, length 2208 is greater than length 2210, and length 2210 is greater than the length of transducer 2215. If transducer 2215 is much shorter than the length of end 2209 (e.g., less than one third of the length of end 2209), together with the internal surface of opening 2205 having a small angle θ, some of the acoustic waves transmitted by transducer 2215, such as waves 2216 and 2217 may undergo multipath propagations within opening 2205. For example, wave 2216 may propagate directly up, while wave 2217, nearer to the internal surface of opening 2205, may propagate sideway towards the internal surface of through opening 2205 and get reflected. There can be phase difference between waves 2216 and 2217, destructive interference can occur between those waves at a certain angle within the field of view, creating a blind spot 2230 as shown in FIG. 22B. The destructive interference reduces the transmit (and reflected) acoustic wave power within blind spot 2230, thereby reducing the bistatic sensor's sensitivity within the blind spot.

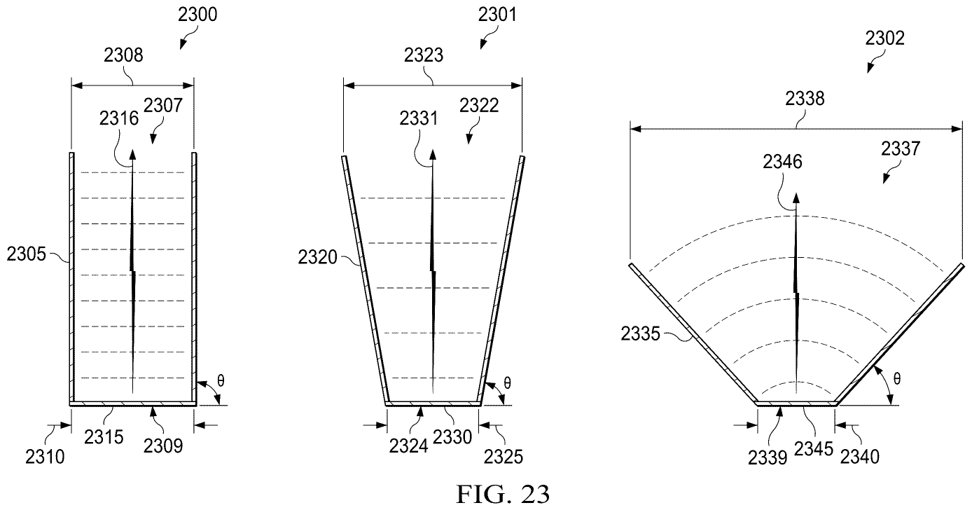

Accordingly, it may be advantageous to extend transducer 2215 across at least one third (or more) the length of end 2209 or end 2207, examples of which follow in FIG. 23. Furthermore, it may be advantageous to center transducer 2215 with respect to a midpoint of end 2209, and to increase the slope angle θ to improve the directivity of the acoustic wave to facilitate propagation along a direction perpendicular to 2209, which can reduce multi-path propagation and the ensuing destructive interference and blind spot. In some examples, to avoid such interference, the length of end 2209 may be selected based on the length of transducer 2215 such that a ratio between the length of 2209 and the length of transducer 2215 does not exceed a value of three, with the slope angle θ between 45 to 90 degrees. With a larger slope angle, the length of the transducer can be made smaller (but no less than one-third of the length of end 2209), and with a smaller slope angle, the length of the transducer can be made larger, to avoid the blind spot issue.

FIG. 23 illustrates example aspects of acoustic waveguides and signals passing through the acoustic waveguides in an implementation. FIG. 23 shows aspects 2300, 2301, and 2302. Aspect 2300 includes a view of a through opening 2305 of an acoustic waveguide (e.g., acoustic waveguide 2100) and dimensions thereof. Aspect 2301 includes a view of a through opening 2320 of an acoustic waveguide (e.g., acoustic waveguide 2100) and dimensions thereof. Aspect 2302 includes a view of through opening 2335 of an acoustic waveguide (e.g., acoustic waveguide 2100) and dimensions thereof.

Through openings 2305, 2320, and 2335 are each representative of one of two or more openings that penetrate a respective acoustic waveguide, such as through opening 2110, and provide an opening through which acoustic waves propagate to or from a transducer of a bistatic sensor, such as transmit acoustic transducer 2010 or receive acoustic transducer 2015, respectively.

In the aspects shown in FIG. 23, through openings 2305, 2320, and 2335 are applied to individual transducers, transducers 2315, 2330, and 2345, respectively. Transducers 2315, 2330, and 2345 are representative of transmit acoustic transducers (e.g., transmit acoustic transducer 2010) configurable to transmit acoustic waves that travel within a respective through opening outwards (i.e., away from the transducer) to an object.

Referring more specifically to through opening 2305 of aspect 2300, through opening 2305 includes a first end proximal to transducer 2315, end 2309, and a second end distal from transducer 2315, end 2307. End 2307 includes a length 2308, and end 2309 includes a length 2310. In this example, length 2308 is the same as length 2310, and length 2310 is the same as the length of transducer 2315. As a result of these dimensions, transducer 2315 produces acoustic waves 2316 having a plane perpendicular to the walls of through opening 2305.

Referring next to through opening 2320 of aspect 2301, through opening 2320 includes a first end proximal to transducer 2330, end 2324, and a second end distal from transducer 2330, end 2322. End 2322 includes a length 2323, and end 2324 includes a length 2325. In this example, length 2323 is greater than length 2325, and length 2325 is the same as the length of transducer 2330. As a result of these dimensions, transducer 2330 produces acoustic waves 2331 having a plane wave similar to the shape of the walls of through opening 2305.

In either case shown in aspects 2300 and 2301, the directivity of the acoustic waves produced by respective transducers may be a function of the dimensions of the mouth (ends 2307 and 2322, respectively) and the wave shape at the mouth. The following equation 2 may be used to determine the directivity of the acoustic waves, where directivity refers to the angle at which the transmission amplitude of acoustic waves drops by 3 dB, where D is the directivity, k is the wave number, where k=2*π/h, λ=c/f, c is acoustic velocity, f is frequency, a is the radius of the mouth, θ is the angle between the wall of the opening and the transducer, and J₁ represents the Bessel function of a 1^{st} kind:

$$D ( θ ) = \frac{2 {J}_{1} ( k asin θ )}{k asin θ} \qquad ( Equation 2 )$$

Referring to through opening 2335 of aspect 2302, through opening 2335 includes a first end proximal to transducer 2345, end 2339, and a second end distal from transducer 2345, end 2337. End 2337 includes a length 2338, and end 2339 includes a length 2340. In this example, length 2338 is more than two times greater than length 2340, and length 2340 is the same as the length of transducer 2345. As a result of these dimensions, transducer 2345 may produce acoustic waves 2346 that are more unfocused with respect to directivity relative to acoustic waves 2331 and 2316, which may be less advantageous to performance of the bistatic sensor compared to the two above aspects. This can also increase the likelihood of multi-path propagation and lead to blind spot, if the length of the transducer is much than length 2340.

Accordingly, the dimensions of the through openings may be selected such that the slope of the walls of the through openings are within threshold values to maintain focused acoustic waves with measurable directivity following the above equation.

Other dimensions of the through openings and transducers may be selected to produce acoustic waves in accordance with the above equation. For example, the dimensions of the through openings may be selected such that a ratio between the length of the throat of the through opening (e.g., end 2309) and the length of a respective transducer does not exceed a threshold ratio (i.e., the length of the throat is not significantly larger than the length of the transducer). In another example, the transducer may be positioned such that it is centered (with respect to at least one axis) on a midpoint of the throat of the through opening.

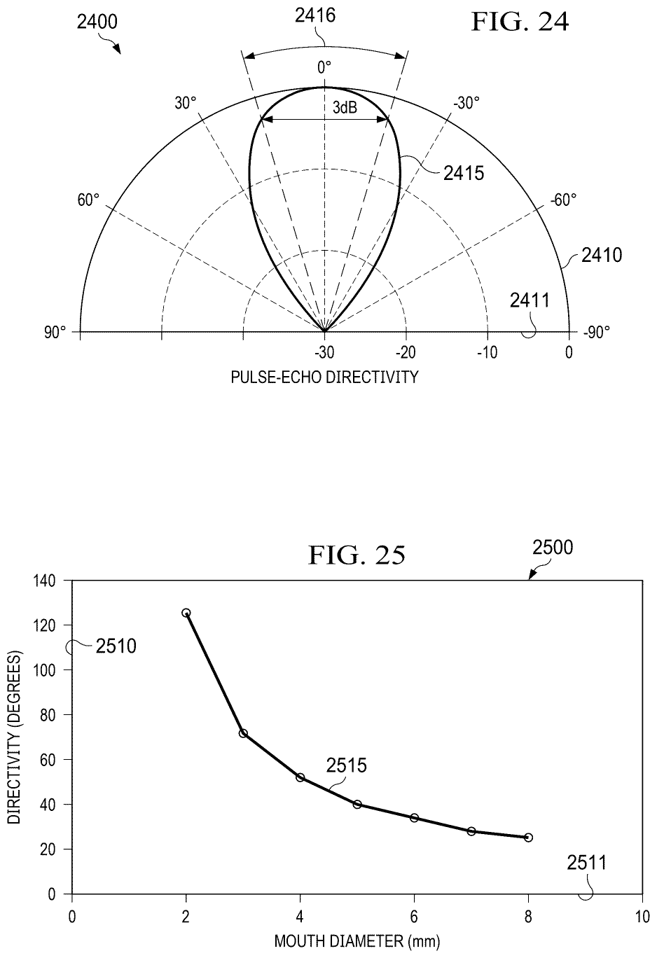

FIG. 24 illustrates an example graphical representation of signal directivity produced by one or more transducers of a bistatic sensor in an implementation. FIG. 24 shows graphical representation 2400, which includes a waveform 2415 having values corresponding to pulse-echo directivity with respect to frequency 2411 and angle 2410.

In particular, waveform 2415 is a representation of an ideal directivity plot produced by measuring acoustic waves produced by a transducer (e.g., transmit acoustic transducer 2010). At zero degrees, the signal strength of the acoustic waves may be the strongest. This may correspond to zero dB. As shown by waveform 2415, acoustic waves are produced having a maximum amplitude/power at frequency 2411 and experiences a drop in amplitude of 3 dB of less (relative to at frequency 2411) at a field of view of angle 2416 with respect to angle 2410. In various examples, an acoustic waveguide (e.g., acoustic waveguide 2100, as well as various dimensions of openings/openings of package material and other layers of a packaged integrated circuit (e.g., packaged integrated circuit 2005) may impact the signal strength and the field of view. Accordingly, such directivity may be shaped as desired by selecting variations of dimensions of such aspects.

FIG. 25 shows graphical representation 2500, which includes a waveform 2515 having values with respect to mouth diameter 2511 and directivity 2510. Waveform 2515 demonstrates varying dimensions of an acoustic waveguide in an implementation and relative impacts on the directivity of acoustic waves produced by a transducer of a bistatic sensor. Accordingly, the discussion below includes and references elements of FIGS. 21, 23, and 24.

In graphical representation 2500, mouth diameter 2511 refers to a diameter of an end of a through opening of acoustic waveguide distal from a transducer, such as mouth 2111 of through opening 2110. Directivity 2510 refers to a pulse-echo directivity of acoustic waves produced by the transducer, which may correspond to a range of degrees when the amplitude of acoustic waves transmitted by a transmit acoustic transducer drops by at least 3 dB. It follows that the smaller the mouth is with respect to mouth diameter 2511, the greater the field of view of the transducer is with respect to directivity 2510 before the strength of the acoustic waves reduces substantially (e.g., by 3 dB). Conversely, the wider the mouth, the weaker and more unfocused the acoustic waves become.

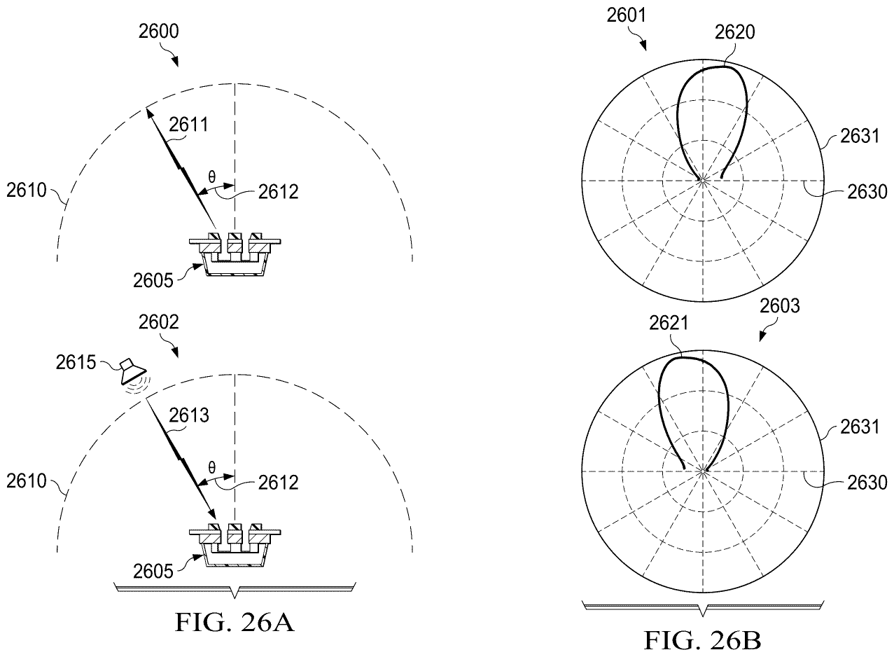

FIG. 26A includes schematics illustrating transmit and receive operations of a sensor package, and FIG. 26B includes graphs illustrating the transmit and receive signal directivities of the sensor package. FIG. 26A shows operating environments 2600 and 2602, which includes bistatic sensor system 2605. Also, FIG. 26B shows graphical representations 2601 and 2603. Graphical representation 2601 includes directivity pattern 2620 for operating environment 2600, and graphical representation 2603 includes directivity pattern 2621 for operating environment 2602.

Referring first to operating environment 2600, operating environment 2600 represents an environment in which bistatic sensor system 2605 transmits acoustic waves 2611 into a space at angle 2612. Bistatic sensor system 2605 may be representative of an apparatus that includes a transmit acoustic transducer (e.g., transmit acoustic transducer 2010), a receive acoustic transducer (e.g., receive acoustic transducer 2015), and circuitry (e.g., transmit driver 110, receive amplifier 114, control circuit 118, AFE 232, or variations and combinations thereof) encapsulated in a package material (e.g. housing 315, frame 317) (collectively, a packaged integrated circuit, such as packaged integrated circuit 1705) and an acoustic waveguide (e.g., acoustic waveguide 2025) applied to the transmit and receive acoustic transducers.

In operation, circuitry may provide an electrical signal to the transmit acoustic transducer of bistatic sensor system 2605, causing the transmit acoustic transducer to transmit acoustic waves 2611 outward from bistatic sensor system 2605 at angle 2612 relative to field of view 2610 based on the shape, dimensions, and positioning of the transducers, openings in the package material, and openings in the acoustic waveguide, for example. The strength of acoustic waves 2611 may be measured by a sensor placed externally relative to bistatic sensor system 2605. The strength and directivity of the transmit acoustic transducer is plotted in graphical representation 2601 as directivity pattern 2620, which shows values relative to frequency 2630 and angle 2631.

Referring next to operating environment 2602, operating environment 2602 represents an environment in which bistatic sensor system 2605 receives acoustic waves 2613 from sensor 2615 at angle 2612. Upon receiving acoustic waves 2613, circuitry can measure the received strength of acoustic waves 2613 to determine the strength and directivity of the receive acoustic transducer of bistatic sensor system 2605. The strength and directivity of the receive acoustic transducer is plotted in graphical representation 2603 as directivity pattern 2621, which shows values relative to frequency 2630 and angle 2631.

In various examples, directivity patterns 2620 and 2621 are symmetrical with respect to each other relative to zero degrees of angle 2631 based on a symmetrical design of elements of bistatic sensor system 2605, which may advantageously improve performance and predictability with respect to performance of bistatic sensor system 2605. To obtain the pulse-echo directivity of bistatic sensor system 2605, an example of which is shown and described with respect to FIG. 24, one may multiply directivity pattern 2620 and directivity pattern 2621.

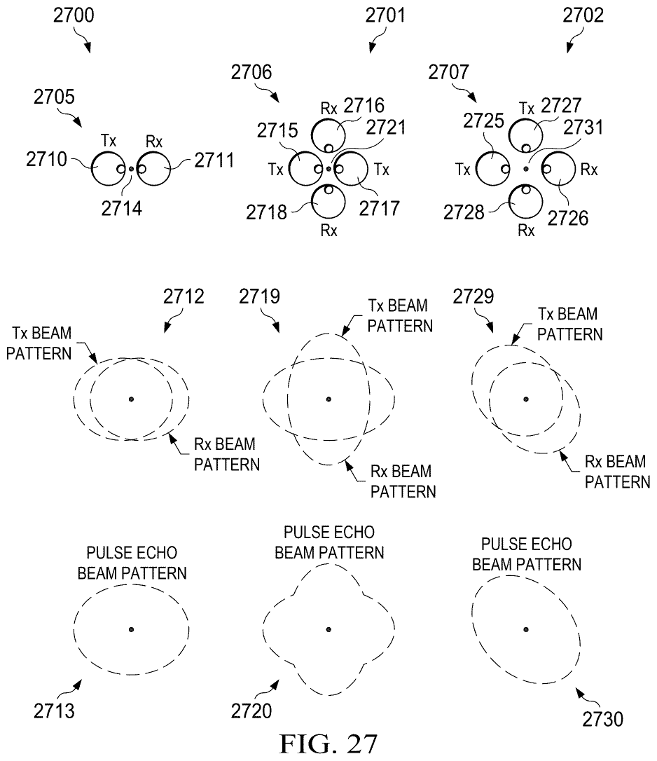

FIG. 27 illustrates example aspects related to acoustic waveguides in an implementation. FIG. 27 includes an acoustic waveguide configuration 2700 and corresponding beam/directivity patterns 2712 and 2713, an acoustic waveguide 2701 and corresponding beam patterns 2719 and 2720, and an acoustic waveguide 2702 and corresponding beam patterns 2729 and 2730.

Each of acoustic waveguide configurations 2700, 2701, and 2702 represents a top-down view of a set of through openings of an acoustic waveguide (e.g., acoustic waveguide 2100). In various examples, an acoustic waveguide may be applied to a sensor system (e.g., packaged integrated circuit 2005) in ultrasonic sensor applications to shape and direct signals outgoing from a transmitter or incoming to a receiver of the sensor system. For example, the acoustic waveguide includes two “through openings,” or openings penetrated through the acoustic waveguide that provide shaped (e.g., curved, cylindrical, conical, tapered combinations or variations thereof) openings in the acoustic waveguide through which a transmitter and receiver (e.g., transducers, resonators) can output and receive signals, respectively.

Waveguide configuration 2700 shows acoustic waveguide 2705 that includes through opening 2710 and through opening 2711. Through openings 2710 and 2711 include a first end (e.g., a throat) that, when applied to a sensor, is positioned proximally to a transmit acoustic transducer and a receive acoustic transducer, respectively, and a second end (e.g., a mouth) that, when applied to a sensor, is positioned distally from the transmit acoustic transducer and the receive acoustic transducer, respectively.

In various examples, the transmit and receive acoustic transducers of the sensor system are positioned symmetrically relative to one another with respect to a middle point of the sensor system, represented by middle point 2714. As such, through openings 2710 and 2711 are also positioned symmetrically relative to one another with respect to middle point 2714.

Despite symmetrical positioning of the mouths of through openings 2710 and 2711, the throats are not necessarily symmetrical relative to middle point 2714. This may cause beam patterns 2712 of the transmit acoustic transducer and receive acoustic transducer to be asymmetrical, however, the multiplication of beam patterns 2712 results in a symmetrical pulse-echo beam pattern as evidenced by beam pattern 2713.

Waveguide configuration 2701 shows acoustic waveguide 2706 that has through openings 2715, 2716, 2717, and 2718. In this configuration, through openings 2715 and 2717 are associated with transmit acoustic transducers, and through openings 2716 and 2718 are associated with receive acoustic transducers. In this configuration, through openings 2715 and 2717, and through openings 2716 and 2718, are positioned symmetrically relative to middle point 2721. As a result, beam patterns 2719 of the pair of transmit and receive acoustic transducers are symmetrical relative to middle point 2721, however, the symmetrical pulse-echo beam pattern is not as evidenced by beam pattern 2720.

Waveguide configuration 2702 shows acoustic waveguide 2707 that has through openings 2725, 2726, 2727, and 2728. In this configuration, through openings 2725 and 2727 are associated with transmit acoustic transducers, and through openings 2726 and 2728 are associated with receive acoustic transducers. In this configuration, neither transmit acoustic transducer-associated through openings (through openings 2725 and 2727) nor receive acoustic transducer-associated through openings (through openings 2726 and 2728) are positioned symmetrically relative to middle point 2721. Due to this asymmetry, beam patterns 2729 of the pair of transmit and receive acoustic transducers are also asymmetrical, however, the multiplication of beam patterns 2729 results in a symmetrical pulse-echo beam pattern as evidenced by beam pattern 2730.

Other configurations of an acoustic waveguide with respect to a number of through openings, positioning of through openings, size/shape of through openings, and the like may be contemplated. Importantly, each pair of transmit and receiver transducer-associated through openings should be positioned symmetrically relative to each other with respect to a middle point of the acoustic waveguide to produce a symmetrical pulse-echo beam pattern, which advantageously improves performance of the transmit and receiver transducers.

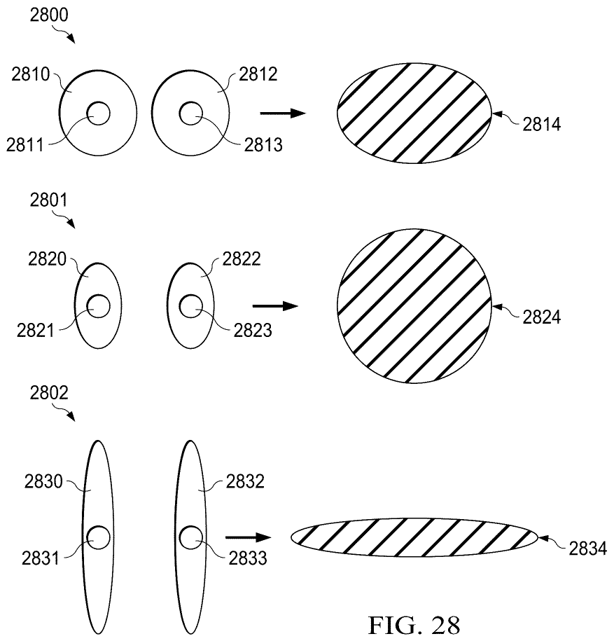

FIG. 28 illustrates example aspects related to acoustic waveguides in an implementation. FIG. 28 includes top-down views of acoustic waveguides 2800, 2801, and 2802 and also includes corresponding directivity patterns 2814, 2824, and 2834, respectively.

In each of the views of acoustic waveguides 2800, 2801, and 2802 a set of through openings is shown which represent openings penetrated through the acoustic waveguide that provide shaped (e.g., curved, cylindrical, conical, tapered combinations or variations thereof) openings in the respective acoustic waveguides through which a transmitter and receiver (e.g., transducers, resonators) can output and receive signals, respectively, when the acoustic waveguides are applied to a sensor system (e.g., packaged integrated circuit 2005).

Acoustic waveguide 2800 includes a first through opening having a first end 2810 (e.g., a mouth) and a second end 2811 (e.g., a throat), and a second through opening having a first end 2812 (e.g., a mouth) and a second 2813. In this configuration, first end 2810 and second end 2811 of the first through opening are concentric circles having the same shape with second end 2811 being smaller than first end 2810. Similarly, first end 2812 and second end 2813 of the second through opening are concentric circles having the same shape with second end 2813 being smaller than first end 2812. It follows that the first and second through openings taper from respective first ends to respective second ends extending a length of acoustic waveguide 2800. As a result of this configuration of acoustic waveguide 2800, a sensor system including acoustic waveguide 2800 may produce directivity pattern 2814 during operation thereof.

Acoustic waveguide 2801 includes a first through opening having a first end 2820 (e.g., a mouth) and a second end 2821 (e.g., a throat), and a second through opening having a first end 2822 (e.g., a mouth) and a second 2823. In this configuration, first end 2820 includes an elongated oval shape, while second end 2821 includes a circular shape overlapped by first end 2820. Similarly, first end 2822 includes an elongated oval shape, while second end 2823 includes a circular shape overlapped by first end 2822. The first and second through openings taper from respective first ends to respective second ends extending a length of acoustic waveguide 2801, however the shape of the mouths differs from that of acoustic waveguide 2800. As a result of this configuration of acoustic waveguide 2801, a sensor system including acoustic waveguide 2801 may produce directivity pattern 2824 during operation thereof.

Acoustic waveguide 2802 includes a first through opening having a first end 2830 (e.g., a mouth) and a second end 2831 (e.g., a throat), and a second through opening having a first end 2832 (e.g., a mouth) and a second 2833. In this configuration, first end 2830 includes an elongated oval shape, while second end 2831 includes a circular shape overlapped by first end 2830. Similarly, first end 2832 includes an elongated oval shape, while second end 2833 includes a circular shape overlapped by first end 2832. The first and second through openings taper from respective first ends to respective second ends extending a length of acoustic waveguide 2802, however the shape of the mouths differs from that of acoustic waveguides 2800 and 2801. As a result of this configuration of acoustic waveguide 2802, a sensor system including acoustic waveguide 2802 may produce directivity pattern 2834 during operation thereof.

While some examples provided herein are described in the context of an integrated circuit and bistatic sensing system, and in particular, to bistatic ultrasonic sensing systems and devices, the sensor calibration and sensor operation methods, techniques, and systems described herein are not limited to such examples and may apply to a variety of other processes, systems, applications, devices, and the like.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a wopening and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in various examples,” “in some examples,” “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics, or semiconductor components.

A circuit or device that is described herein as including certain components may instead be adapted to be coupled to those components to form the described circuit or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits/devices described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means being within +/−10 percent of that parameter or, if the parameter is zero, a reasonable range of values around zero.

What is claimed is:

1. A packaged integrated circuit comprising:
a first acoustic transducer;
a second acoustic transducer;
a transmit circuit coupled to the first acoustic transducer;
a receive circuit coupled to the second acoustic transducer;
a control circuit coupled to an output of the receive circuit; and
a package material covering at least parts of the first acoustic transducer, the second acoustic transducer, the transmit circuit, the receive circuit, and the control circuit.

2. The packaged integrated circuit of claim 1, wherein the first and second acoustic transducers include resonators having different resonant frequencies.

3. The packaged integrated circuit of claim 2, wherein a first difference between the resonant frequencies of the first and second acoustic resonators is several orders of magnitudes higher than a second difference caused by a random mismatch between two resonators configurable to have a same resonant frequency.

4. The packaged integrated circuit of claim 2, wherein:
the first acoustic transducer has a first 3 dB frequency range; and
the second acoustic transducer has a second 3 dB frequency range different from the first 3 dB frequency range, and the second resonant frequency is outside the first 3 dB frequency range.

5. The packaged integrated circuit of claim 4, wherein the first and second 3 dB frequency ranges do not overlap.

6. The packaged integrated circuit of claim 2, wherein the first acoustic transducer and the second acoustic transducer are separated a threshold distance from each other within the package material based on respective resonant frequencies.

7. The packaged integrated circuit of claim 2, wherein one or more dimensions of the first acoustic transducer are based on the first resonant frequency, and one or more dimensions of the second acoustic transducers are based on the second resonant frequency.

8. The packaged integrated circuit of claim 7, wherein each of the first and second acoustic transducers includes a respective capacitive micromachined ultrasonic transducer (CMUT).

9. The packaged integrated circuit of claim 7, wherein each of the first and second acoustic transducers includes a respective piezoelectric micromachined ultrasonic transducer (PMUT).

10. The packaged integrated circuit of claim 1, further comprising a package substrate on which the first acoustic transducer, the second acoustic transducer, the transmit circuit, the receive circuit, and the control circuit is mounted, wherein the packaging material covers at least part of the package substrate.

11. The packaged integrated circuit of claim 10, wherein the packaging material includes a metal housing.

12. The packaged integrated circuit of claim 10, wherein the packaging material includes a mold compound.

13. The packaged integrated circuit of claim 10, wherein the package substrate includes a first opening and a second opening, the first acoustic transducer being over the first opening, and the second acoustic transducer being over the second opening, a first dimension of the first opening being based on the first resonant frequency, and a second dimension of the second opening being based on the second resonant frequency.

14. The packaged integrated circuit of claim 13, wherein the package substrate includes at least one of: a lead frame, or a laminate of multiple metal layers and insulation material.

15. The packaged integrated circuit of claim 1, wherein the control circuit is configurable to, in a first operation:
cause the transmit circuit to transmit a first signal at the second resonant frequency;
receive a second signal via the receive circuit; and
provide a third signal responsive to the second signal.

16. The packaged integrated circuit of claim 15, wherein the second signal is reflection of the first signal by an object, and the third signal indicates a detection of the object.

17. The packaged integrated circuit of claim 15, wherein the control circuit is configurable to, in a second operation:
cause the transmit circuit to transmit a fourth signal at a frequency;
receive a fifth signal via the receive circuit;
determine the second resonant frequency based on the fourth and fifth signals; and
store data representing the second resonant frequency; and
wherein the control circuit is configurable to cause the transmit circuit to transmit the first signal at the second resonant frequency based on the data in the first operation.

18. The packaged integrated circuit of claim 17, wherein the fifth signal is received via a coupling of the fourth signal as crosstalk between the first and second acoustic transducers.

19. The packaged integrated circuit of claim 18, wherein the data is first data, and the control circuit is configurable to, in the second operation, determine second data representing the crosstalk based on the fourth and fifth signals; and
provide the third signal by processing the second signal with the second data in the first operation.

20. The packaged integrated circuit of claim 19, wherein the first signal includes a first number of cycles, the second signal includes a second number of cycles, the first number being larger than the second number.

21. The packaged integrated circuit of claim 20, wherein the first number of cycles is based on a quality factor (Q) of the second acoustic transducer.

22. The packaged integrated circuit of claim 17, wherein the control circuit is configurable to perform the second operation periodically.

23. The packaged integrated circuit of claim 17, wherein the control circuit is configurable to perform the second operation prior to the first operation.

24. A system comprising:
a bistatic sensor package including:
a first acoustic transducer having at a first resonant frequency;
a second acoustic transducer having a second resonant frequency different from the first resonant frequency; and
an analog front end coupled to the first and second acoustic transducers; and
a processor coupled to the bistatic sensor package and configurable to:
cause the first acoustic transducer to transmit a first signal at the second resonant frequency;
receive a second signal via the second acoustic transducer; and
provide a third signal responsive to the second signal.

25. The system of claim 24, wherein the bistatic sensor package and the processor are part of an integrated circuit.

26. The system of claim 24, wherein the second signal is reflection of the first signal by an object, and the third signal indicates a detection of the object.

27. The system of claim 24, wherein the processor is configurable to:
cause the transmit circuit to transmit a fourth signal at a frequency;
receive a fifth signal via the receive circuit;
determine the second resonant frequency based on the fourth and fifth signals; and
store data representing the second resonant frequency; and
wherein the processor is configurable to cause the transmit circuit to transmit the first signal at the second resonant frequency based on the data.

28. The system of claim 27, wherein the fifth signal is received via a coupling of the fourth signal as crosstalk between the first and second acoustic transducers.

29. The system of claim 28, wherein the data is first data, and the processor is configurable to determine second data representing the crosstalk based on the fourth and fifth signals; and
provide the third signal by processing the second signal with the second data in the first operation.

30. The system of claim 24, wherein the first and second acoustic transducers include resonators having different resonant frequencies.

31. The system of claim 30, wherein a first difference between the resonant frequencies of the first and second acoustic resonators is several orders of magnitudes higher than a second difference caused by a random mismatch between two resonators configurable to have a same resonant frequency.

32. The system of claim 30, wherein:
the first acoustic transducer has a first 3 dB frequency range; and
the second acoustic transducer has a second 3 dB frequency range different from the first 3 dB frequency range, and the second resonant frequency is outside the first 3 dB frequency range.

33. The system of claim 32, wherein the first and second 3 dB frequency ranges do not overlap.

34. The system of claim 33, wherein each of the first and second acoustic transducers includes a respective capacitive micromachined ultrasonic transducer (CMUT).

35. The system of claim 33, wherein each of the first and second acoustic transducers includes a respective piezoelectric micromachined ultrasonic transducer (PMUT).

36. A method comprising:
transmitting, using a first acoustic transducer having a first resonant frequency, a first signal at a frequency different from the first resonant frequency;
receiving, using a second acoustic transducer having a second resonant frequency different from the first resonant frequency, a second signal; and
generating a third signal representing detection of an object responsive to the second signal.

37. The method of claim 36, further comprising:
transmitting, using the first acoustic transducer, a fourth signal at a frequency;
receiving, using the second acoustic transducer, a fifth signal;
determining the second resonant frequency based on the fourth and fifth signals;
storing data representing the second resonant frequency;
wherein transmitting a first signal at a frequency includes transmitting the first signal at the second resonant frequency based on the data.

38. The method of claim 28, wherein the fifth signal is received via a coupling of the fourth signal as crosstalk between the first and second acoustic transducers, the data is first data, and the method further comprises:
determining second data representing the crosstalk based on the fourth and fifth signals; and
providing the third signal by processing the second signal with the second data.

39. The method of claim 27, wherein the first and second acoustic transducers are part of an integrated circuit.
